(19) United States
(12) Patent Application Publication
(10) Pub. No.: US 2008/0029135 A1
(43) Pub. Date: Feb. 7, 2008

(54) CAR WASH APPARATUS WITH PIVOTABLE ARMS

(76) Inventors: Dennis R. McCadden, Wheatridge, CO (US); Eric Engen, Bailey, CO (US); David M. Gauthier, Denver, CO (US)

Correspondence Address: DORSEY & WHITNEY, LLP;INTELLECTUAL PROPERTY DEPARTMENT, 370 SEVENTEENTH STREET, SUITE 4700, DENVER, CO, 80202-5647, US

(21) Appl. No.: 11/828,792

(22) Filed: Jul. 26, 2007

Related U.S. Application Data
(63) Continuation-in-part of application No. 11/455,466, filed on Jun. 19, 2006.

(51) Int. Cl. B60S 3/04

(52) U.S. Cl. 134/123

(57) ABSTRACT

An apparatus for washing a vehicle that is relatively moved through the apparatus includes pivotal side arms with independently pivotal nozzles for the dispensing of cleansing fluids as well as a pivotal overhead boom that also includes independently pivotal nozzles so that the side arms and the boom as well as the nozzles associated therewith can be optimally positioned for directing high pressure liquid at the vehicle. The side arms and boom are also moved from retracted to extended positions with power cylinders and retracted from the extended to retracted positions by counter balancing weights.

### CROSS REFERENCE TO RELATED APPLICATION

This application is a Continuation-in-Part to U.S. application Ser. No. 11/455,466 filed Jun. 19, 2006, which is hereby incorporated by reference as if fully disclosed herein.

### BACKGROUND OF THE INVENTION

1. Field of the Invention

The present invention relates generally to apparatus for washing automotive vehicles wherein the vehicle moves past the apparatus or the apparatus moves relative to the vehicle. The apparatus is an overhead apparatus having a boom pivotal about a horizontal axis extending horizontally over a vehicle and side arms pivotal about vertical axes disposed along opposite sides of the vehicle with the boom and the arms each including nozzles that are pivotal independently of the boom and side arms themselves to desirably position the nozzles relative to the vehicle as it moves relative to the apparatus.

2. Description of the Relevant Art

The washing of automotive vehicles has been automated for some years with various types of apparatus in the art for washing vehicles. There are tunnel type car wash systems wherein a car is advanced along a path of travel beneath a plurality of arched wash apparatus so that a sequence of operations occurs to thoroughly wash the vehicle. For example, a vehicle in such a tunnel wash system might first encounter a pre-soak system wherein soap or another chemical for breaking down dirt or film on the surface of the car is first applied, then a high pressure wash apparatus wherein the treated dirt and film is removed from the vehicle, thereafter the vehicle may pass through a system for applying a chemical to the vehicle to prepare the vehicle for receiving a rinse and wax solution after a rinse and wax solution is actually applied and subsequently the vehicle passes through a dryer where air is blown across the vehicle to remove excess water and treating fluids.

An alternative to a tunnel car wash is a gantry type system wherein an inverted U-shaped housing is reciprocated back and forth along the length of the car while the car remains stationary. During each successive pass of the gantry along the length of the vehicle, various operations occur such as the application of a pre-soak solution, a high pressure removal of the pre-soak solution, the application of a treatment anticipatory of a rinse and wax treatment, and, finally, a rinse and wax treatment. After the gantry has finished its various processes and its reciprocating movement along the length of the vehicle, the vehicle can be advanced through a blow dryer to remove excess water and treating fluids.

In either type of the afore-described systems, one of the vehicle or wash system is moved relative to the other so that treating fluids are applied to the surface of the vehicle in a sequence of front to rear or rear to front of the vehicle.

Some car washes are touch-free where no mechanical device touches the surface of the vehicle, other's are friction washes wherein rotating brushes or other abrasive materials engage the vehicle to mechanically remove dirt, film or other debris from the vehicle. There are advantages and disadvantages to the brush systems or the touch free systems. Further, some systems profile a vehicle so that information relating to the vehicle can be fed into a computer that operates the wash system whether it is a tunnel type system or a reciprocating gantry system. In other words, the length of the vehicle as well as its height and longitudinal profile are frequently determined so that nozzles, brushes or the like used in the car wash systems can be properly and desirably positioned for optimal treatment of the vehicle.

Research is ongoing to optimize the automated cleansing of a vehicle with minimal adverse effects to the vehicle while obtaining optimal cleansing with economics of energy and water always being a concern.

It is to provide improvements in car wash systems of the above type that the present invention has been developed.

### SUMMARY OF THE INVENTION

While the present invention will be described as being a washing component of a tunnel type system wherein a vehicle is moved past the system at a predetermined rate, it will be readily apparent to those skilled in the art that the system could also be reciprocally mounted for movement back and forth along a stationary vehicle. A description of a system for reciprocating the system back and forth along the length of the vehicle will not be described even though such systems are well known in the art.

The system of the present invention has an inverted U-shaped gantry-type housing with a pair of vertical legs on opposite sides of a path of travel for a vehicle and a horizontal leg overlying the path of travel. The system includes side arms pivotal about vertical axes that can be moved into the path of the vehicle or retracted to the side of the path of travel. The side arms have nozzles that are independently pivotable to optimize the angle at which the nozzles spray washing fluid on the vehicle. The vertical sides of the system also include a set of vertically spaced, fixed nozzles primarily adapted for washing the sides and wheels of the vehicle as the vehicle passes thereby.

A horizontal boom is mounted in the leg of the housing overlying the path of travel. The boom can be pivotally lowered into the path of travel of the vehicle or raised out of the path of travel of the vehicle. The boom has a plurality of horizontally spaced nozzles which are independently pivotal relative to the boom itself so that the nozzles can be desirably positioned relative to the vehicle for optimal delivery of washing fluids.

Drive cylinders are provided in the system for lowering the overhead boom from its raised to its lowered position and for pivoting the side arms between retracted and extended positions. Counter balancing weights are utilized for raising the boom so that the counterbalancing weights cooperate with the drive cylinders as a back-up in moving the overhead boom to its position.

A computerized system is employed for detecting movement and size of a vehicle being washed with that information being used to operate a powered system for moving the arms and the boom at predetermined times relative to the movement of the vehicle.

Other aspects, features and details of the present invention can be more completely understood by reference to the following detailed description of a preferred embodiment taken in conjunction with the drawings and from the dependent claims.

### BRIEF DESCRIPTION OF THE DRAWINGS

FIG. 1 is a diagrammatic isometric of a tunnel car wash system incorporating the wash apparatus of the present invention.

FIG. 2 is a fragmentary isometric with parts removed for clarity showing the wash apparatus of the present invention.

FIG. 3 is an enlarged section taken along line 3-3 of FIG. 2.

FIG. 3A is a section taken along line 3A-3A of FIG. 3.

FIG. 3B is a section taken along line 3B-3B of FIG. 3.

FIG. 3C is a section taken along line 3C-3C of FIG. 3B.

FIG. 3D is a view similar to FIG. 3C with the boom in a lowered position.

FIG. 3E is a view similar to FIG. 3D with the boom fully lowered and the nozzles tilted in a reverse direction.

FIG. 3F is an isometric showing the boom in the position of FIG. 3E.

FIG. 3G is an isometric similar to FIG. 3F showing the boom in the position of FIG. 3D.

FIG. 4 is a section taken along line 4-4 of FIG. 2.

FIG. 4A is a section taken along line 4A-4A of FIG. 4.

FIG. 5 is a diagrammatic isometric showing the working components of the apparatus of the present invention.

FIG. 6A is a diagrammatic top plan view illustrating the operation of the apparatus with a vehicle initially approaching the apparatus.

FIG. 6B is a diagrammatic top plan view similar to FIG. 6A with the vehicle having progressed downstream.

FIG. 6C is a diagrammatic top plan view similar to FIG. 6B with the vehicle further progressed downstream.

FIG. 6D is a diagrammatic top plan view similar to FIG. 6C with the vehicle leaving the wash apparatus.

FIG. 7A is a diagrammatic side elevation showing a vehicle having entered the apparatus of the invention.

FIG. 7B is a diagrammatic side elevation similar to FIG. 7A with the vehicle further progressed downstream.

FIG. 7C is a diagrammatic side elevation similar to FIG. 7B with the vehicle even further moved downstream.

FIG. 8A is a diagrammatic side elevation showing a vehicle of higher profile approaching the apparatus.

FIG. 8B is a diagrammatic side elevation similar to 8A with the vehicle further downstream.

FIG. 8C is a diagrammatic side elevation similar to 8B with the vehicle even further downstream.

FIG. 8D diagrammatic side elevation showing the vehicle of FIG. 8C leaving the apparatus.

FIG. 9 is a vertical section of a turbo nozzle.

FIG. 10 is an isometric view of a rotating nozzle member of a turbo nozzle.

FIG. 11 is a section of the rotating nozzle member taken along line 11-11 of FIG. 10.

FIG. 12 is a section of the turbo nozzle taken along line 12-12 of FIG. 9.

FIG. 13 is a section of the rotating turbo nozzle taken along line 13-13 of FIG. 9.

FIG. 14 is a section of the turbo nozzle taken along line 14-14 of FIG. 9.

FIG. 15 is a section similar to FIG. 14 illustrating a variation of the rotating nozzle member at line 14-14.

FIG. 16 is a partial section of a prior art fast rotating turbo nozzle taken along line 11-11 of FIG. 10 having a single inlet orifice into the nozzle body.

FIG. 17 is a partial section of a slow rotating turbo nozzle taken along line 11-11 of FIG. 10 having four inlet orifices into the nozzle body.

FIG. 18A is a fragmentary isometric showing one end of the overhead boom in an alternative embodiment with the nozzles shown directed downwardly.

FIG. 18B is a fragmentary isometric similar to FIG. 18A where the boom has been tilted downwardly and the nozzles rotated into a different angular orientation than that shown in FIG. 18A.

FIG. 19A is a fragmentary isometric looking at a side housing component in an alternative embodiment from internally of the U-shaped housing and with the side arm fully retracted.

FIG. 19B is a fragmentary isometric similar to FIG. 19A wherein the side arm is fully extended.

FIG. 20 is a diagrammatic fragmentary isometric looking downwardly on the boom in an alternative embodiment with the boom fully retracted.

FIG. 21 is an exploded isometric showing three components of the framework for the U-shaped housing which are sized for convenient shipping.

FIG. 22 is an isometric showing the components of FIG. 21 assembled and showing the overhead boom of FIG. 18A incorporated therein.

FIG. 23A is an isometric of the side arm of FIG. 19A on one side of the U-shaped housing in a fully retracted position and shown within the U-shaped housing which is illustrated in dashed lines.

FIG. 23B is an isometric similar to FIG. 23A showing an opposite side of the U-shaped frame from that shown in FIG. 23A and with the side arm of FIG. 19A being fully extended even though the side arms as illustrated in FIGS. 23A and 23B illustrating the alternative embodiment shown in FIGS. 19A and 19B would not have one side extended while the other side was retracted.

### DESCRIPTION OF THE PREFERRED EMBODIMENT

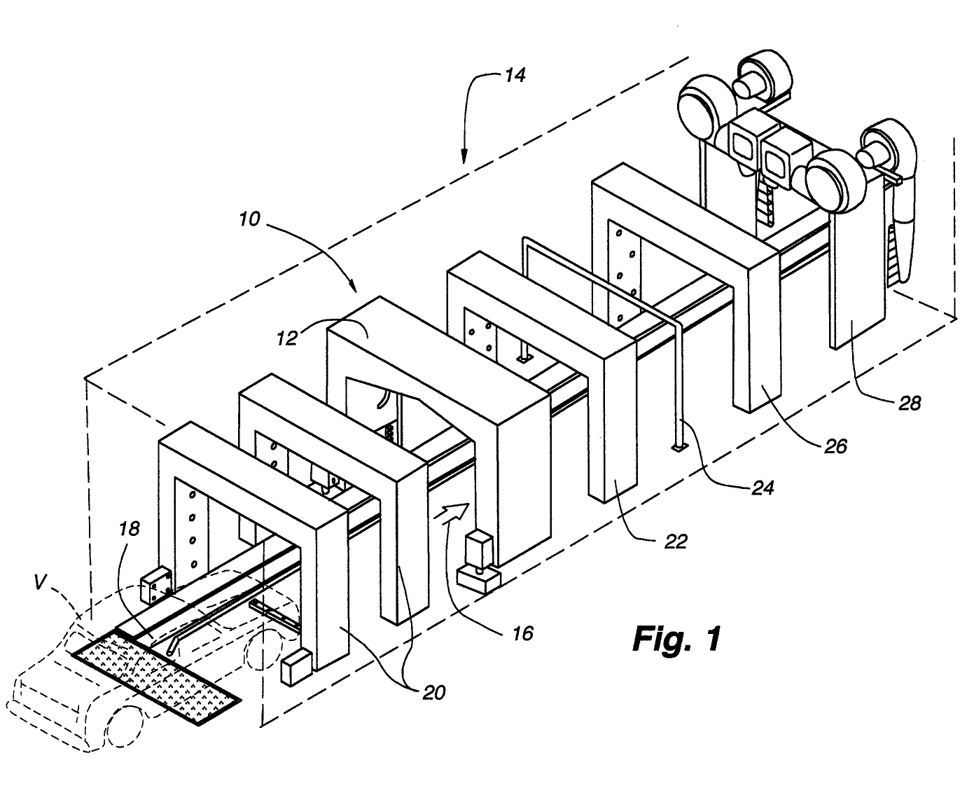

The wash apparatus 10 of the present invention is housed in an inverted U-shaped housing 12 which could form part of a tunnel type car wash system or could be a gantry type system wherein the housing was reciprocally moveable along the length of a stationary automobile so that the gantry was moved back and forth in a plurality of passes to apply the various solutions necessary for a complete wash of the automobile. For purposes of the present disclosure, however, the apparatus of the present invention is shown in FIG. 1 forming a part of a tunnel type car wash system 14 where there are a plurality of fixed stations in the system and a vehicle V is advanced through the system so as to encounter each station where various operations occur.

As will be appreciated by reference to FIG. 1, each station has an inverted U-shaped apparatus for conducting a predetermined operation and a tunnel vehicle path of travel 16 is defined beneath the various apparatus. The system would include a tire guide channel (formed) on the floor along which the left front and rear tires of the vehicle are guided through the system. A conventional push apparatus (not shown) is utilized to advance the vehicle through the system at a predetermined rate. In the system illustrated, the first two apparatus 20 are for the application of a pre-soak solution to chemically break down grime, film or other material that might be on the surface of the vehicle. At the next station, the vehicle would encounter the apparatus 10 of the present invention where a high pressure water wash removes the pre-soak solution along with any film, grime or the like that was loosened with the pre-soak solution. After emerging from the apparatus 10 of the present invention, the vehicle passes through a station 22 where a wax or pre-wax solution is applied to the car and immediately thereafter at a station 24, a low pressure water rinse. Downstream from the low-pressure rinse the vehicle enters a final rinse and wax station 26 where a wax coating is applied to the vehicle. Subsequent thereto, the vehicle passes through a blow dryer 28 so that as the vehicle emerges downstream from the blow dryer, it has been cleaned, waxed and dried.

Tunnel type car washes have been in common usage for many years and are typically computer controlled so that the system knows where a vehicle is at all times and can operate the various component apparatuses in the system. Each apparatus could also have its own sensors for determining the position of a vehicle as well as the vehicle profile as will be described hereafter in connection with the apparatus of the present invention. As mentioned previously, the apparatus of the present invention could be mounted on rollers and reciprocally driven in upstream and downstream directions if it were not part of a tunnel type system, but rather an independent gantry type apparatus. In such a case, the vehicle would be stationary and the apparatus would move back and forth along the length of the vehicle applying the various pre-soak, rinse and wax solutions through the same nozzles. For purposes of the present disclosure, however, the apparatus is disclosed only for applying high pressure water to remove pre-soak solutions and the dirt, grime or film chemically removed therefrom.

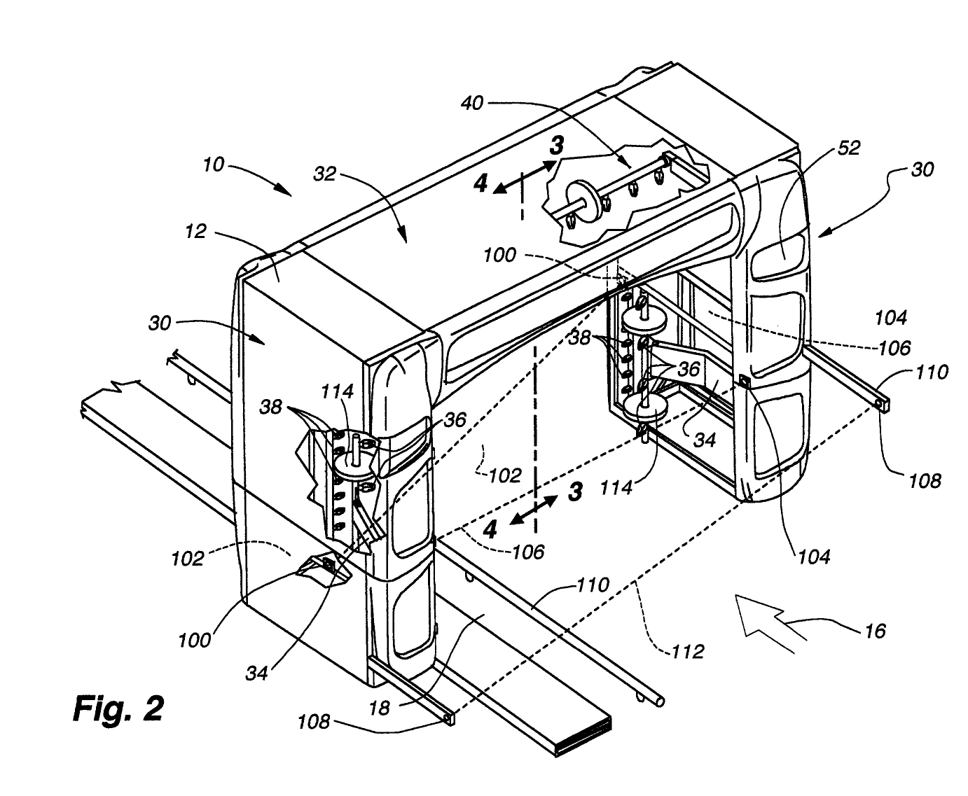

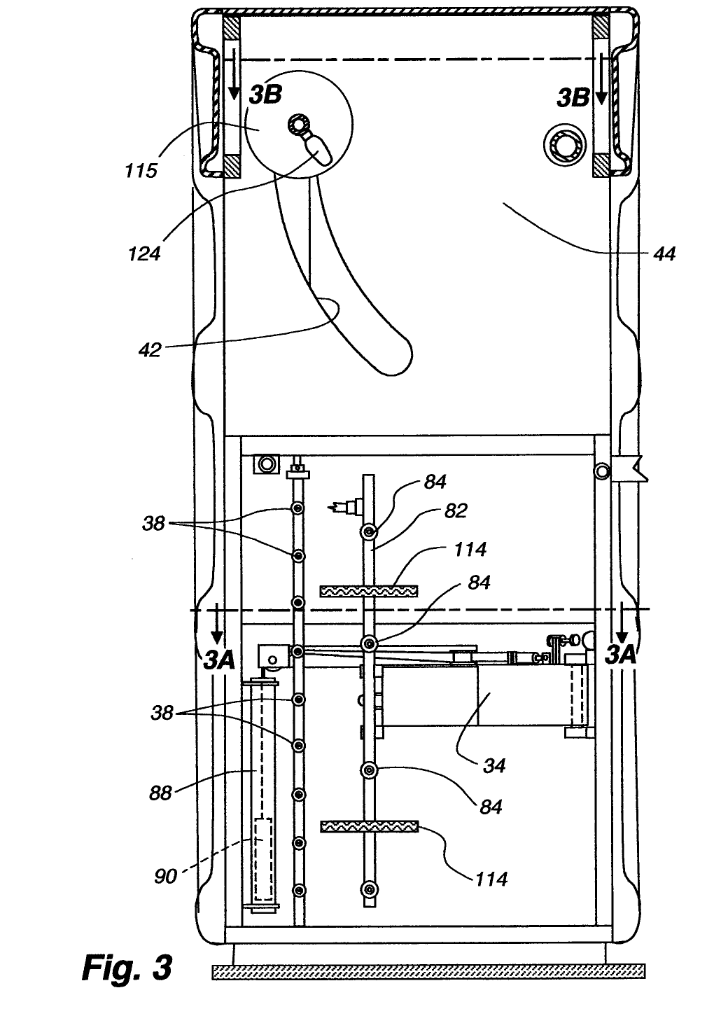

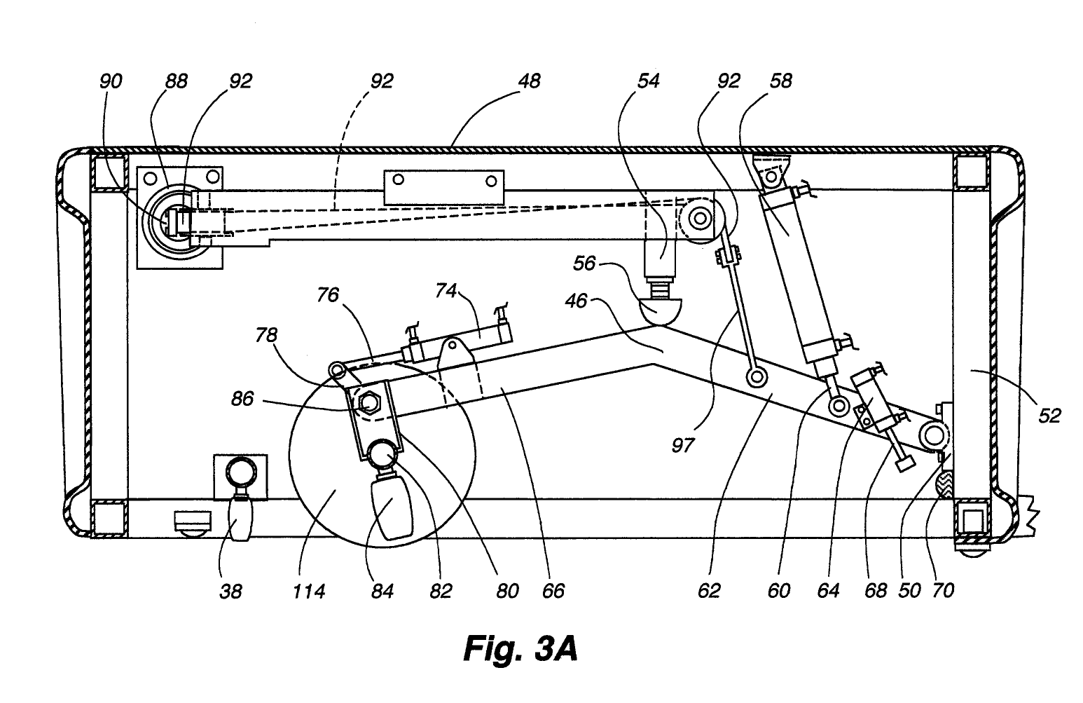

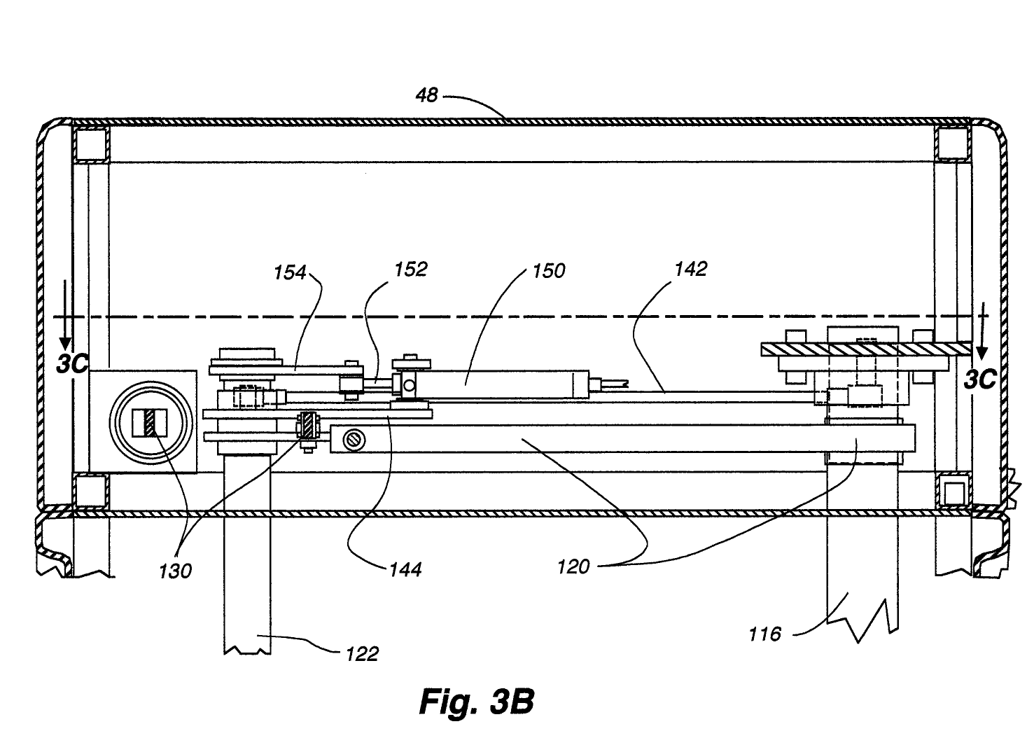

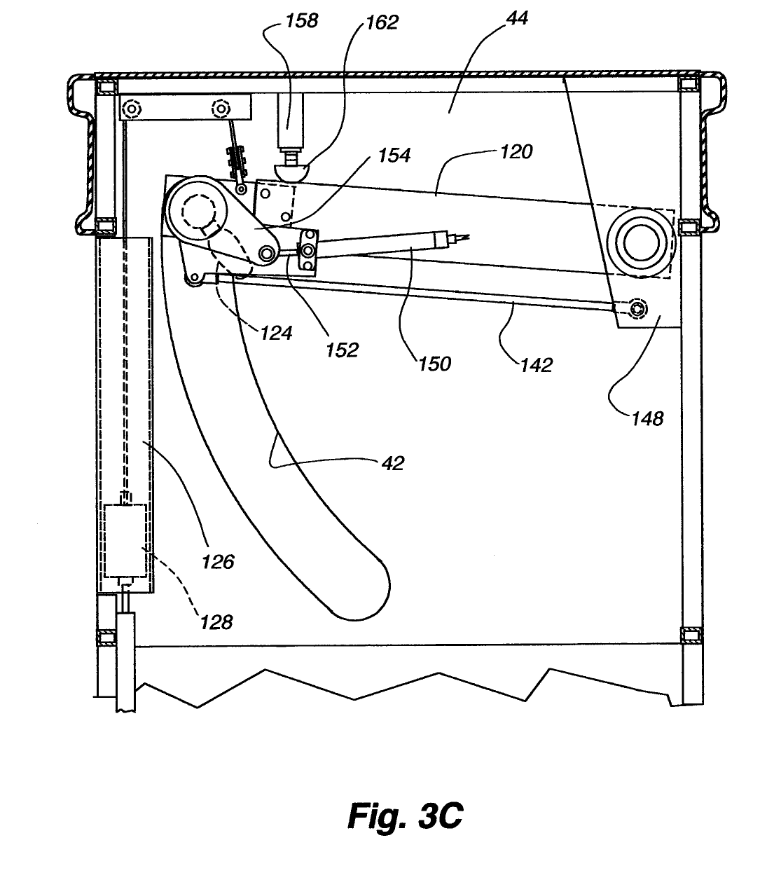

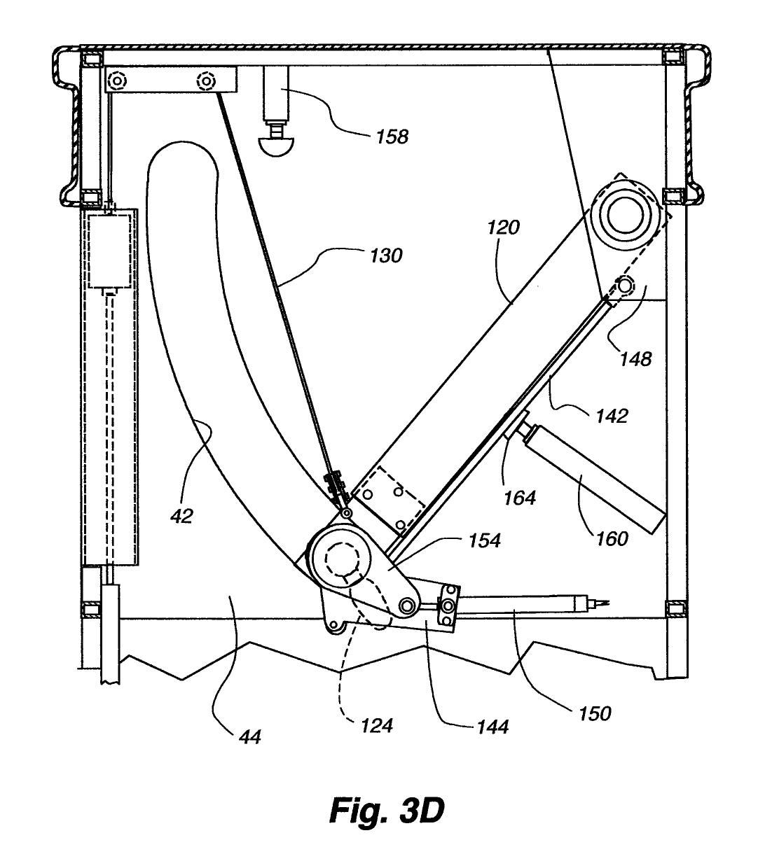

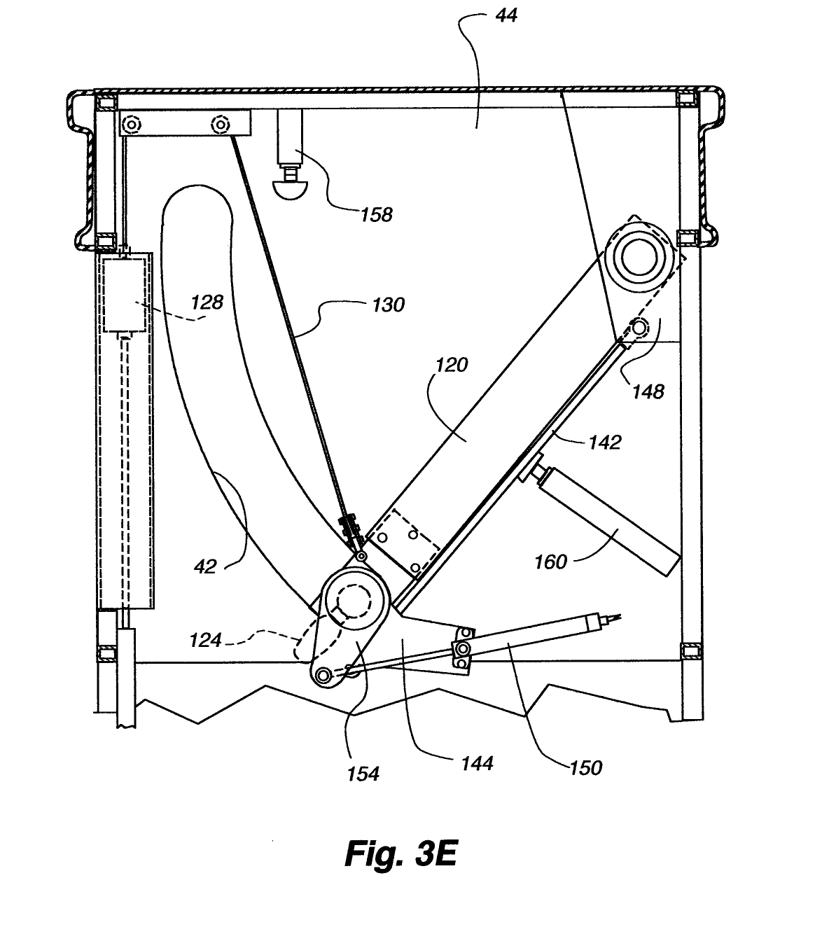

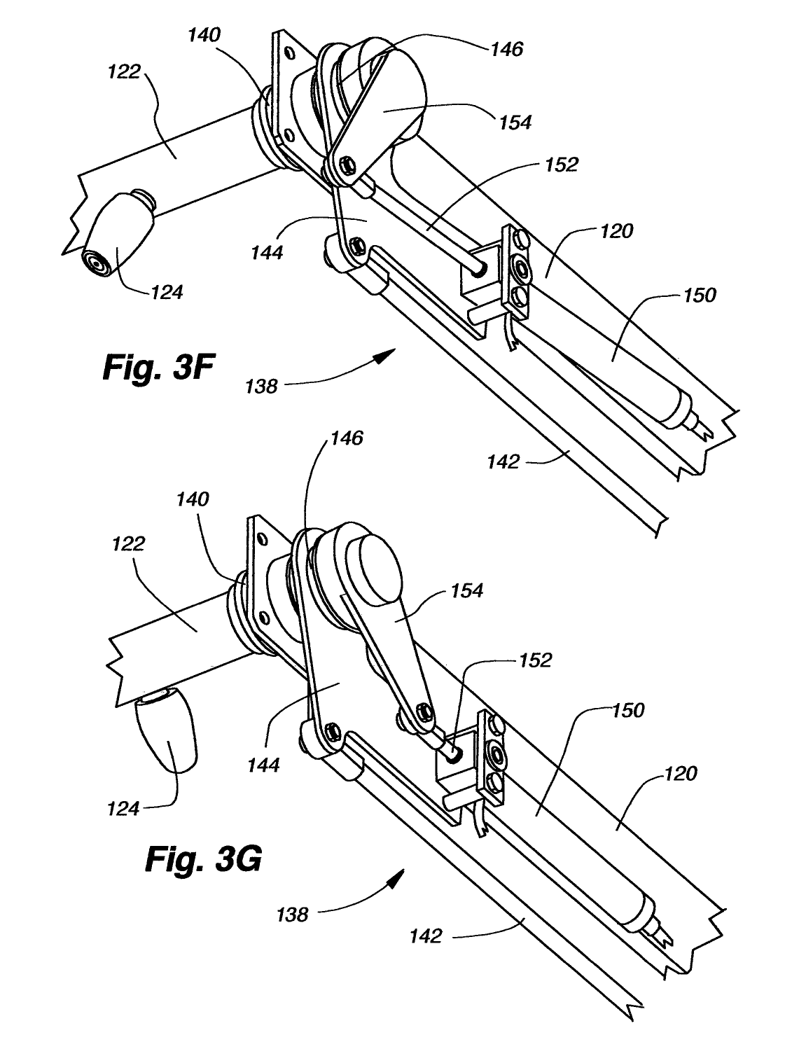

With reference to FIG. 2, and as will be explained in more detail hereafter, the apparatus 10 of the present invention includes the inverted U-shaped housing 12 having two vertically oriented side housing components 30 on opposite sides of the vehicle path of travel 16 and an interconnecting overhead housing component 32. The side components and the overhead component of the housing are all hollow and open inwardly toward the path of travel. The side housing components are substantially identical having pivotal side arms 34 carrying spraying nozzles 36 and an operating mechanism for pivoting the arms about vertical axes so the spray nozzles can be moved into the path of travel 16 or retracted therefrom in predetermined sequence with the movement of a vehicle V through the apparatus. Also positioned in each side housing component is a vertically disposed set of fixed spray nozzles 38 adapted for spraying water on the wheels and sides of the vehicle. In the overhead housing component a pivotal overhead boom 40 is mounted for reciprocating movement from a raised or retracted position of FIG. 2 to a lowered or extended position as seen in FIG. 3D. Dashed lines are also shown in FIG. 2 illustrating infra red beams used to detect various positions and profiles of the vehicle being washed as will be described later. The information gathered from the beams, as when they communicate or are interrupted by a vehicle V, being used to activate various cylinders and nozzles within the apparatus as will be described in more detail hereafter. The beams could be replaced with information gathered at the upstream end of the car wash system with that information being used in a computerized program that knows the length of a vehicle, its side profile, as well as its position anywhere within the system so the information could be used to operate the cylinders and nozzles of the apparatus shown in FIG. 2. For purposes of the present disclosure, however, the beams are illustrated for detecting features of the vehicle and its position relative to the apparatus. Their function will be described in more detail later.

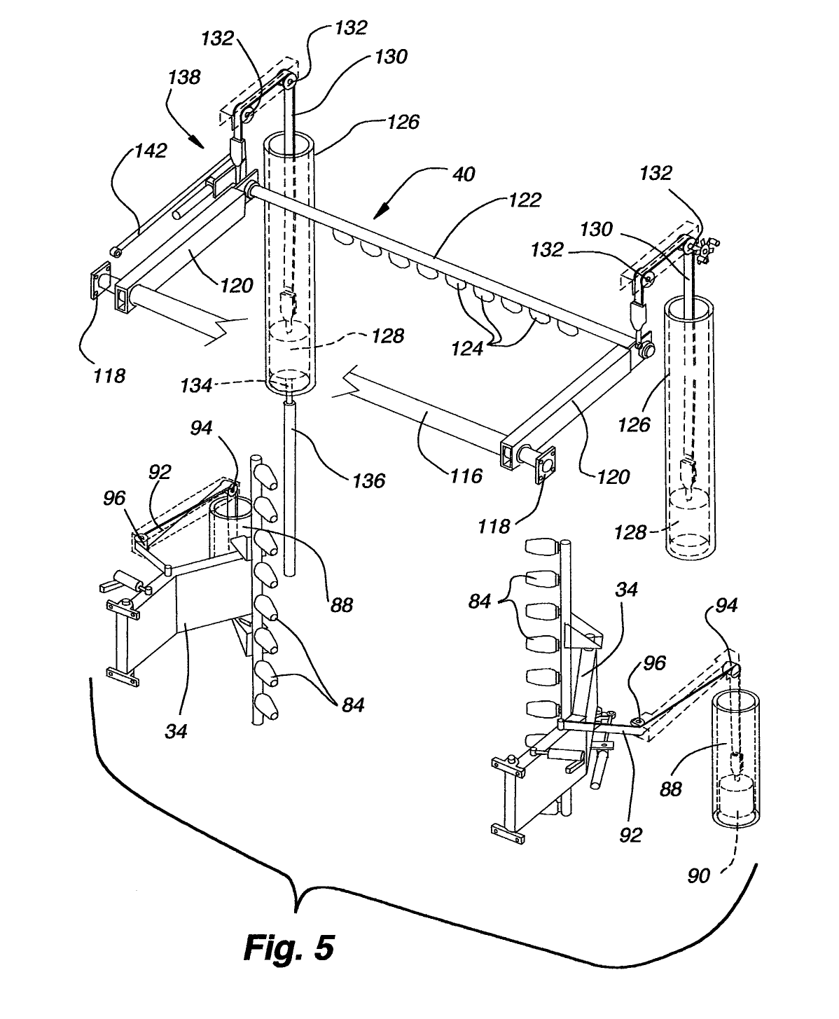

With reference to FIG. 3, it will be seen the overhead boom pivots within an arcuate slot 42 provided in a side wall 44 of a side housing component with the side wall separating the operating components of the system from the vehicle path of travel 16. A more detailed explanation of the operation of the overhead boom 40 will be described hereafter in connection with FIGS. 3B, 3C, 3D, 3E, 3F, and 3G. The overhead boom is also shown in FIG. 5 in diagrammatic format for a better understanding thereof.

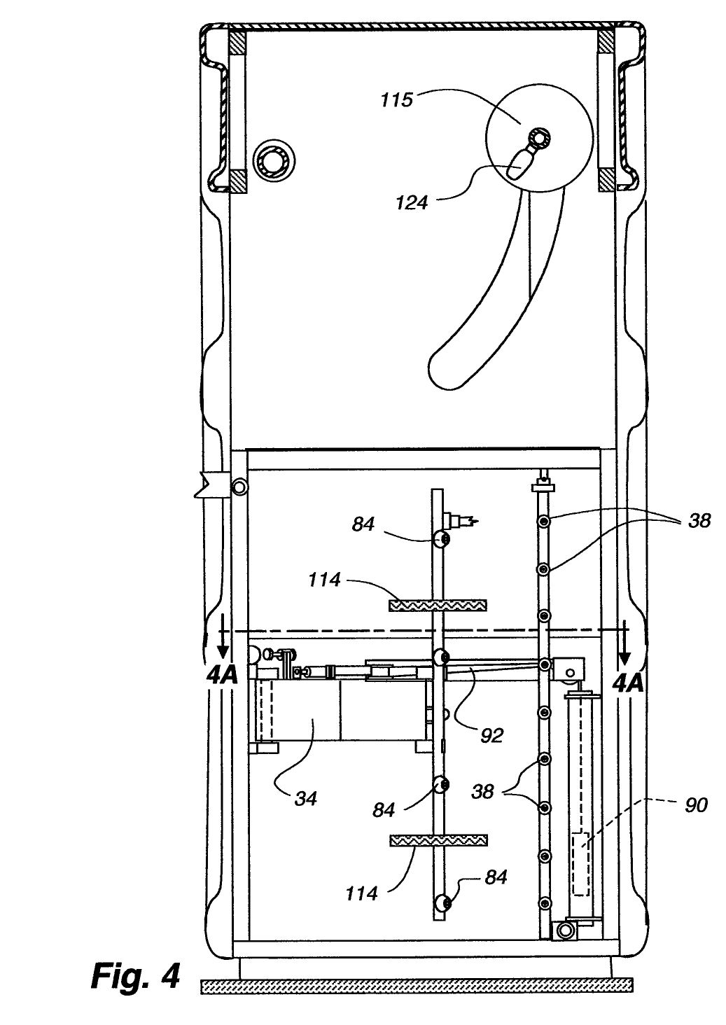

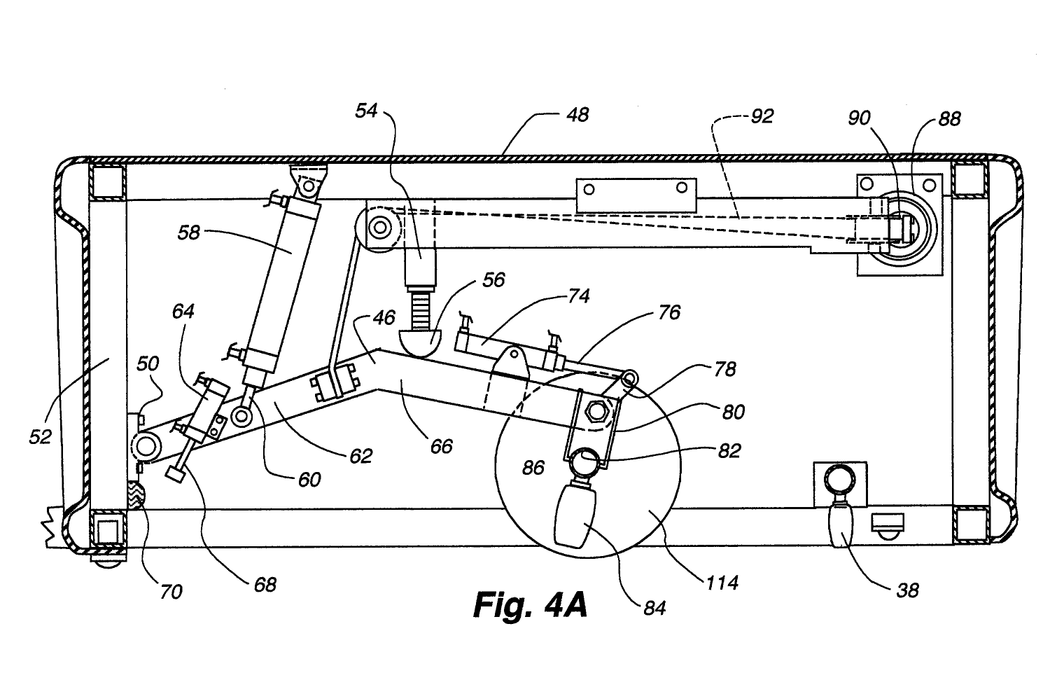

As also seen in FIG. 3, the lower half of the side housing components 30 house the side arms 34 as well as the vertical array of fixed nozzles 38 with a better illustration thereof being found in FIGS. 3A, 4A, as well as the diagrammatic illustration in FIG. 5.

As will be appreciated from the description hereafter, the side arms 34 in each side housing component 30 and the vertical array of fixed nozzles 38 are substantially identical and a mirror image of each other. The only difference resides in the length of the side arm on the left side of the apparatus as viewed in FIG. 2 versus the right side. As will be appreciated, the guide channel or track 18 defined along the floor of the car wash system for guiding the left front and rear tires of the vehicle V is always at a fixed spacing from the left side housing component regardless of the width of the vehicle being washed. The spacing of the right housing component from the right side of the vehicle, however, will vary depending upon the width of the vehicle. In larger SUV-type vehicles, the right side of the vehicle will be closer to the right side housing component whereas in smaller compact vehicles, the right side of the vehicle will be spaced a greater distance from the right side housing component. To accommodate for this variance on the right side of the apparatus, the side arm 34 on the right side housing component has been made slightly longer than the pivot arm 34 on the left side housing component so that the side arm on the right side housing component will on average be positioned relative to the vehicle correspondingly to the side arm on the left side housing component when the side arms are extended inwardly into the path of travel of the vehicle as will be described in more detail hereafter. The operation of the pivotal side arms as well as the fixed nozzles in each side of the housing, however, are identical and, accordingly, like parts have been given like reference numerals with the only distinction being in the length of the pivot arms on the sides of the apparatus.

Referencing FIGS. 3A, 4A, and FIG. 5, it will be seen each pivotal side arm 34 is of a generally flat V-shaped cross-sectional configuration as viewed from the top of the apparatus with the apex 46 of the side arm facing an outer wall 48 of the side housing component 30. One end of the side arm is pivotally connected to a pivot bracket 50 mounted on an upstream wall 52 of the side housing component and an adjustable stopper 54 is mounted on the outer wall of the side housing component having an abutment head 56 adapted to engage the apex of the side arm to limit clockwise rotation of the arm beyond a predetermined location. A drive cylinder 58 has its piston 60 secured to a proximal leg 62 of the side arm with the cylinder housing being pivotally anchored to the outer wall 48 of the side housing component whereby it will be appreciated extension of the drive cylinder will pivot the side arm in a counterclockwise direction while a retraction of the cylinder will occur when the side arm is pivoted in a clockwise direction. A limit cylinder 64 is mounted on the proximal leg 62 of the side arm between the connection of the piston 60 of the drive cylinder 58 and the pivot bracket 50 with the piston 68 of the limit cylinder being adapted to engage an abutment stop 70 on the upstream wall 52 of the side housing component immediately adjacent to the pivot bracket. The limit cylinder, depending upon the extension of its piston rod, is adapted to limit counterclockwise movement of the side arm whereby it can be seen when the piston rod of the limit cylinder is retracted, the side arm can swing through a greater arc than when the piston rod is extended. The cylinder would not necessarily have to be used if, for example, an adjustability in the degree of swing was not desired, as a fixed mechanical stop would also function satisfactorily. It should also be noted while the drive and limit cylinders are shown as pneumatic cylinders, they could be hydraulic cylinders or electrically activated solenoids depending upon the power system being used for the apparatus.

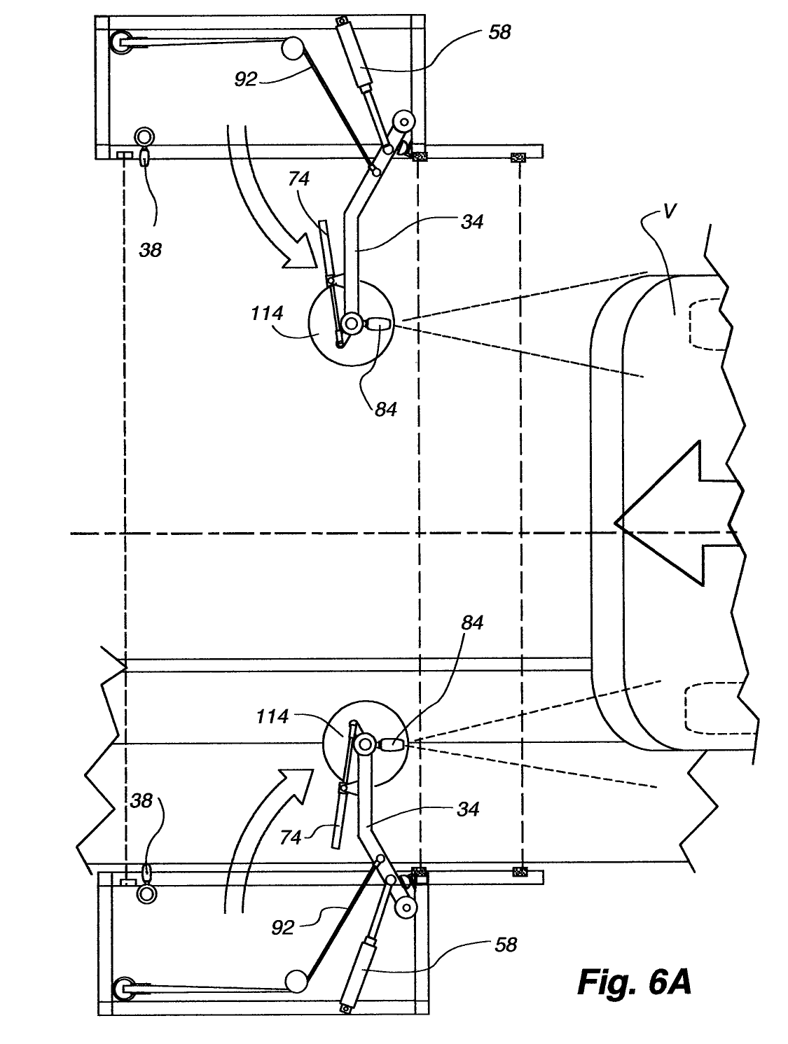

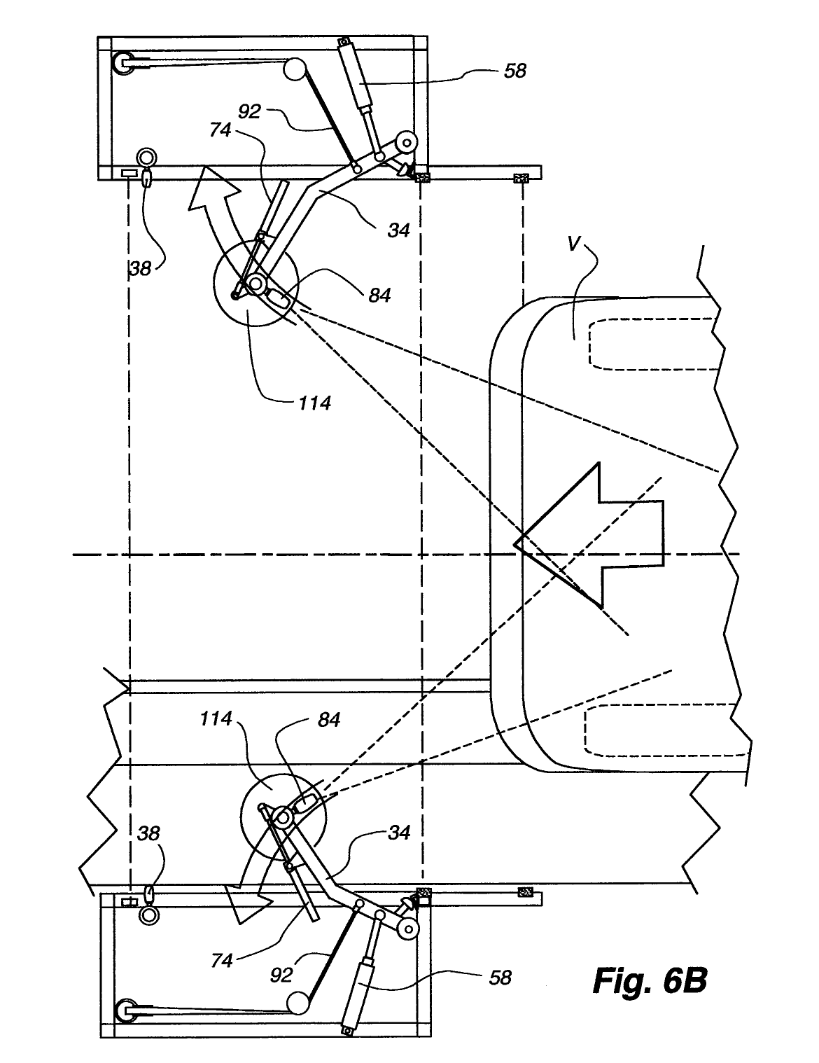

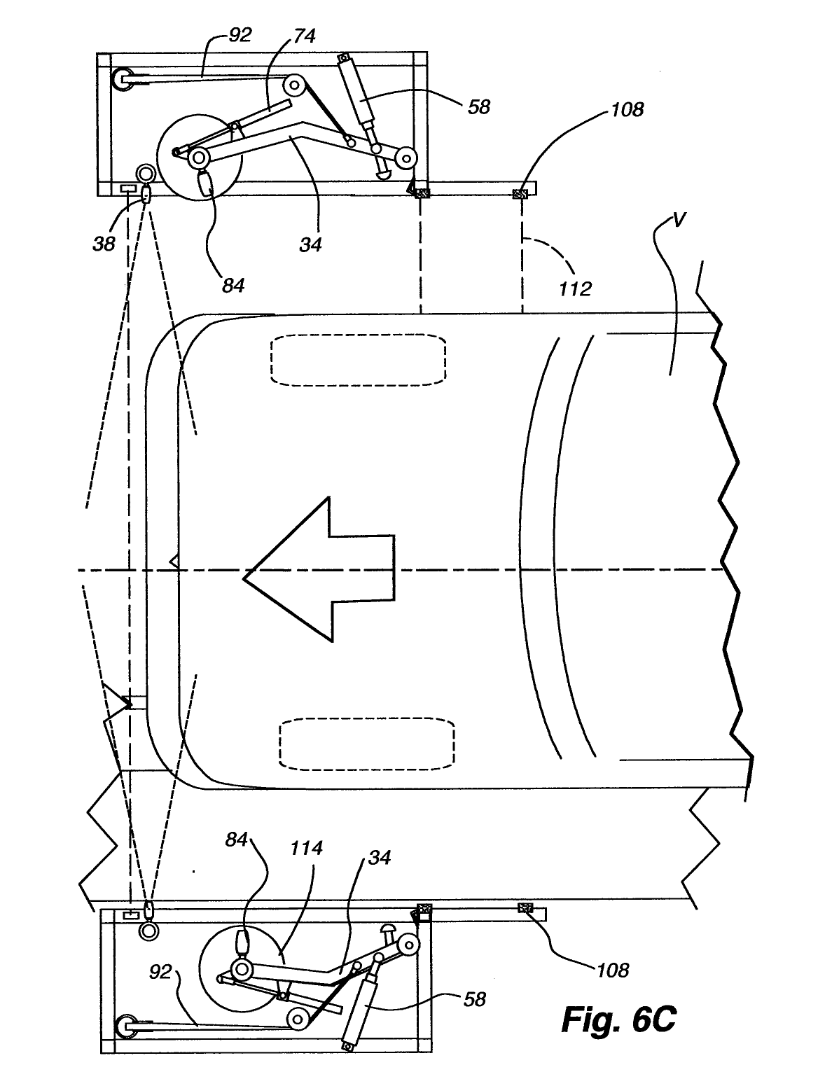

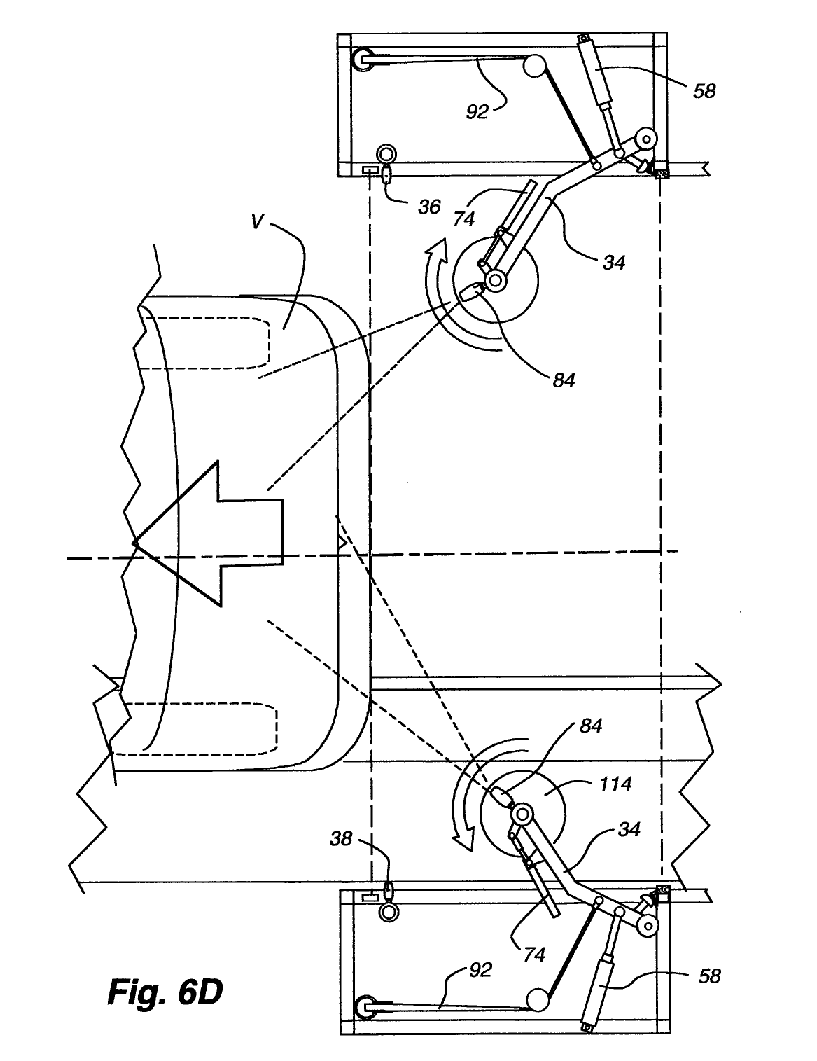

A first operating power cylinder 74 is pivotally mounted on a distal leg 66 of the side arm 34 adjacent to the distal end of the side arm. The piston rod 76 of this cylinder is connected to a lever arm 78 that in turn rotates a vertical mounting bar 80 on which a manifold 82 carrying a plurality of nozzles 84 is mounted. Pivotal movement of the lever arm causes the mounting bar to pivot about a pivot shaft 86 secured to the lever arm and mounting bar. The operating cylinder has been sized so that full extension and retraction of the piston rod 76 pivots the nozzles 84 through an angle greater than 90 degrees and between a position as shown in FIG. 6A, for example, where the nozzle is substantially perpendicular to the distal leg 66 of the side arm and a position substantially parallel to the distal leg of the side arm, as shown in FIG. 6D.

It will be appreciated from the above and as mentioned before, extension of the drive cylinder 58 pivots the side arm 34 in a counterclockwise direction as viewed in FIGS. 3A and 4A and thus moves the side arm between the fully retracted position of FIG. 3A to an extended position as seen for example in FIG. 6A with the extent of the counterclockwise movement being determined by the size of the cylinder 58. To retract the pivot arm from the extended position of FIG. 6A to the retracted or storage position of FIGS. 3A and 4A, a counterbalance system is employed which retracts the plunger of the drive cylinder when the drive cylinder is not activated in extending its plunger.

Again referencing FIGS. 3A, 4A and 5, the counterbalance system can be seen to include a vertical guide tube 88 positioned in the associated side housing component 30 with the guide tube having a slidable, cylindrical weight 90 therein that is suspended from a substantially non-extensible, flexible belt 92 that extends upwardly around a first pulley 94 having a horizontal axis and then horizontally after being turned 90 degrees so that it extends around a second pulley 96 having a vertical axis. The belt is subsequently fixedly attached to a rigid arm 97 on the proximal leg 62 of the side arm. As will be appreciated, when the drive cylinder 58 is activated and its piston rod extended, the side arm pivots in the counterclockwise direction as viewed in FIGS. 3A and 4A thereby raising the counterweight 90 within the guide tube 88, but when the drive cylinder is deactivated, the counterweight drops within its guide tube and through the belt 92 returns the side arm to the retracted position of FIGS. 3A and 4A while also retracting the plunger of the drive cylinder.

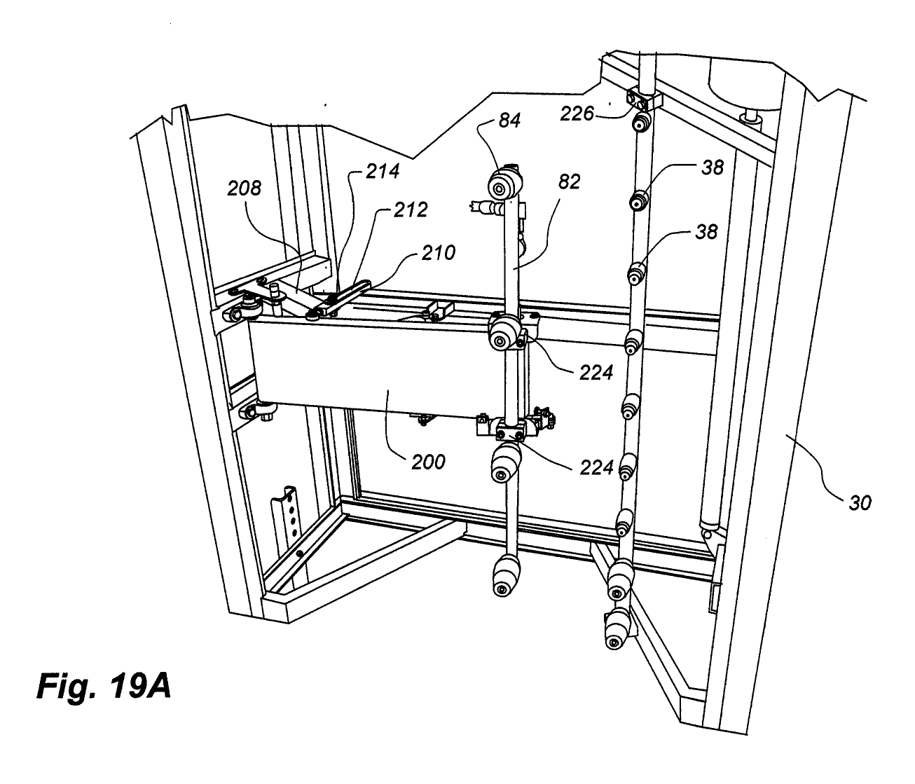

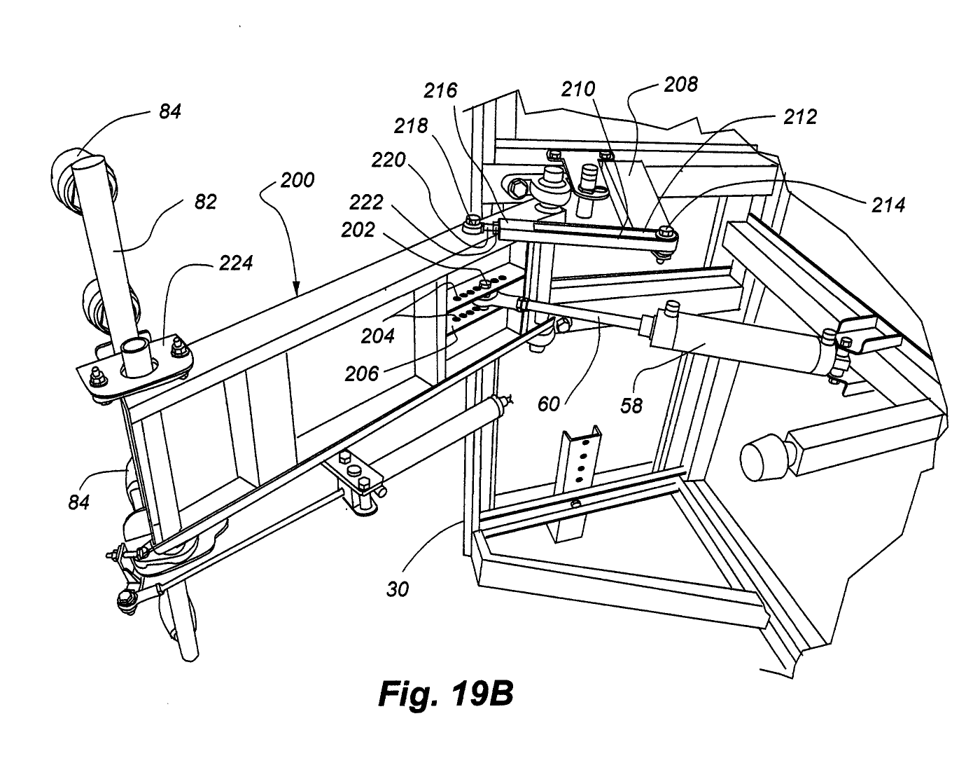

The counterbalance system for the side arms 34 may not be necessary as the reactionary force from liquids being emitted from the nozzles 84 in and of itself is typically sufficient to retract the side arms. By way of example and with reference to FIGS. 19A and 19B, an alternative system is shown where there is no counterbalance system and wherein like parts have been given like reference numerals.

In the alternative system of FIGS. 19A and 19B, the drive cylinder 58 is similarly mounted except its piston rod 60 has its distal end adjustably connected to the side arm 200 with a pivot pin 202 that can be positioned in any one pair of adjacent holes 204 provided in a mounting bracket 206. As will be appreciated, depending upon which hole the pivot pin is positioned in, the side arm will be pivoted or swung a different distance away from the side frame component 30 for a common stroke of the piston rod 60. It will be further noted, the pivotal side arm 200 is not V-shaped as in the previous embodiment of FIG. 3A, for example, but is straight.

The swinging movement of the side arm 200 is positively limited by a limit system (FIG. 19B) that includes a horizontal mounting bracket 208 extending inwardly from the upstream wall 52 of the side housing component 30 with the bracket pivotally and slidably supporting on its distal end an elongated limit arm 210 having an elongated horizontal slot 212 formed along its length which slidably receives a pivot/slide pin 214 secured to the distal end of the bracket. An end 216 of the limit arm is longitudinally and adjustably connected to an anchor pin 218 on the side arm 200 itself with an adjustable rod 220 extending axially away from the slotted limit arm 210 which is adjustable in length with a lock nut 222 so the effective length of the limit arm can be regulated thereby accommodating the desired swinging movement of the side arm 200 depending upon the pair of holes 204 in which the pivot pin 202 for the drive cylinder 58 is positioned. Of course, the length of the slot 212 positively stops the swinging or pivotal movement of the side arm 200 between the extended position of FIG. 19B and a retracted position of FIG. 19A with the pivot/slide pin 214 being at one extreme end of the slot when the side arm is extended (FIG. 19B) and at the other end when it is retracted (FIG. 19A).

In the alternative embodiment illustrated in FIGS. 19A and 19B, the manifold 18A is also slidably mounted on the side arm 200 with adjustable slide mounting brackets 224 so the manifold can be raised or lowered prior to use of the apparatus and locked in a selected position to permit desired positioning of the nozzles. In the alternative embodiment as also seen in FIG. 19A, the manifold for the fixed spray nozzles 38 is also supported with an adjustable slide bracket 226 from the framework of a side frame component 30 so the manifold can also be raised or lowered and locked in any selected position again to position the fixed nozzles at a desired elevation.

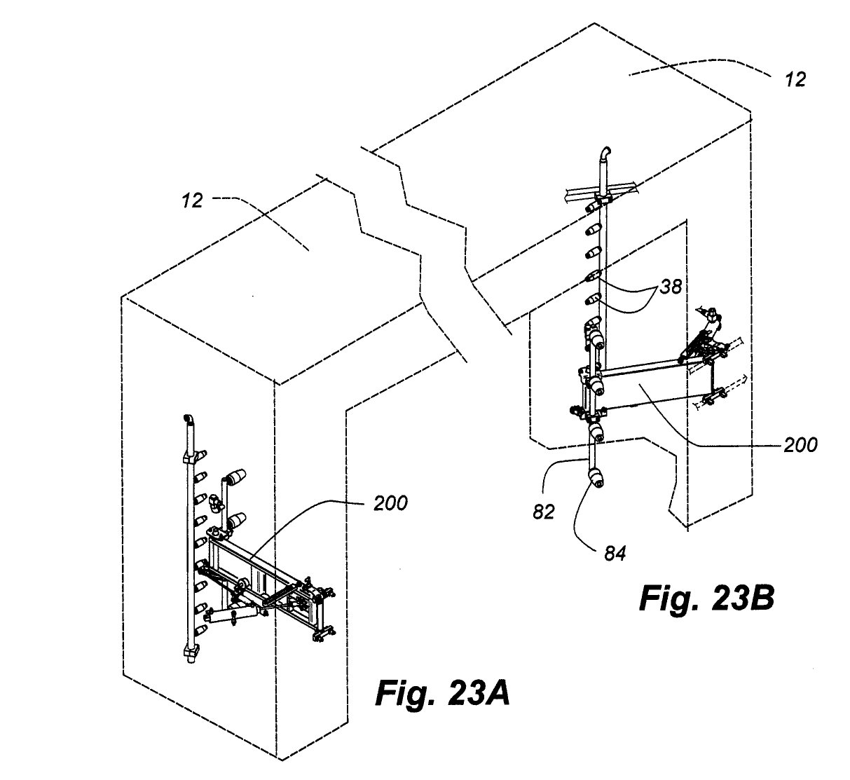

With reference to FIGS. 23A and 23B, the pivot side arms 200 in the alternative embodiment are shown in the U-shaped gantry housing 12, which is illustrated in dashed lines. FIG. 23A shows the pivotal side arm 200 retracted and FIG. 23B shows the pivotal side arm 200 on the opposite side of the gantry fully extended. It should be noted, however, that while FIGS. 23A and 23B are shown side by side, the pivotal side arms 200 on opposite sides of the gantry always move in unison so they would both be extended together and retracted together.

Again referencing the embodiment of FIGS. 3A and 4A, the mounting bar 80 carried on the distal end of the side arm 34 supports the vertically extending manifold 82 that communicates with the plurality of horizontally disposed but vertically separated nozzles 84 which are preferably rotary turbo nozzles of the type described in U.S. patent application Ser. No. 10/791,340, filed Mar. 1, 2004. The specific strength of the nozzles will be described in more detail hereinafter. While it is not illustrated, obviously the manifold is in fluid communication with a high-pressure source of rinse liquid, such as water, for delivery to the vehicle through the nozzles.

The fixed nozzles 38 are secured to the framework of both the left and right side housing components in a vertical line that is downstream from the pivotal nozzles 84. The fixed nozzles are also preferably turbo nozzles of a size to be described in more detail hereafter and connected in fluid communication with a vertically extending manifold 98 that is also in fluid communication with a source of high-pressure cleaning liquid such as water. The two lowermost fixed nozzles are preferably larger than those above them to provide adequate coverage of the wheels and lower sides of the vehicle.

An infrared beam system including sensors 100 is mounted on the housing frame along the inner side of each side housing component 30 in alignment with each other so as to establish a cross beam 102 for detecting the position of the vehicle passing through the apparatus. The beam established by the infrared system is disposed horizontally downstream from the fixed nozzles 38. Another pair of infrared sensors 104 are vertically spaced on the upstream wall 52 of the side housing component 30 and emit cross beams 106 that may be interrupted by a vehicle depending on its height. Further, one more pair of horizontally spaced infrared sensors 108 are mounted on support bars 110 extending upstream from each side housing component which emit beams 112 for detecting the position of a vehicle for purposes to be described hereafter.

As is possibly best appreciated by reference to FIGS. 2, 3A and 4A, the vertical manifolds 82 on each side pivot arm 34 have mounted thereon a pair of bumper disks 114 of a rubber-like material. The radius of the disk is greater than the distance from which the nozzles 84 protrude from the manifold so that should there be a malfunction in the operating system for the apparatus, a vehicle V would engage one of the bumper disks which would apply counter pressure to the drive cylinder 58 and through the computerized system for operating the apparatus, the drive cylinder would be deactivated and the counterbalance system would quickly pivot the side arms to their retracted position and out of the path of travel 16 of the vehicle to avoid damage to the vehicle or to the nozzles. Similar bumper disks 115 (FIG. 3) are mounted on the overhead boom for the same purpose.

The overhead boom 40 is best appreciated by reference to FIGS. 3B-3G and FIG. 5. Looking first at the diagrammatic representation of the overhead boom in FIG. 5, it can be seen to include a pivot shaft 116 pivotally supported on axle brackets 118 anchored to the outer side walls 48 of the overhead housing component with the pivot shaft being fixed to a pair of spaced lift arms 120 disposed along opposite sides of the apparatus. The lift arms pivot with the pivot shaft during operation of the overhead boom. The distal ends of the lift arms support an overhead manifold 122 having a plurality of horizontally spaced nozzles 124 for dispensing liquid onto an underlying vehicle. As will be described hereafter, the manifold is also pivotable about its longitudinal axis so as to pivot automatically relative to the lift arms when the lift arms are pivoted with the pivot shaft and can also be pivoted independently of movement of the pivot shaft. The overhead boom has a counterbalance system for biasing and lifting the boom into the retracted position illustrated in FIGS. 3C and FIG. 5 with the counterbalance system including a pair of vertically disposed guide cylinders 126 mounted on the housing having slidable weights 128 disposed therein. The weights are connected on a top thereof to a flexible, non-extensible belt 130 such as of rubber with the belt passing over a pair of pulleys 132 having horizontal pivot axes before passing downwardly and being connected to the distal ends of the lift arms 120. One of the counterbalance weights is connected on its lower end to the plunger 134 of a vertically oriented drive cylinder 136 such that extension of the drive cylinder lifts the weight allowing the boom 40 to pivot from the retracted position of FIGS. 3C and 5 to the extended position of FIGS. 3D or 3E. The weights are carefully selected so they will raise the boom from the extended position to the retracted position when the drive cylinder 136 is deactivated, as when the plunger 134 is withdrawn into the cylinder, but will move from the retracted position to the extended position upon extension of the drive cylinder.

A linkage system 138 is operatively connected to one lift arm 120 to automatically pivot the manifold 122 as mentioned before upon pivotal movement of the pivot shaft 116. With reference to FIGS. 3F and 3G, it will be appreciated the lift arm at each end of the manifold supports the manifold in a bearing 140 so the manifold is free to pivot about its longitudinal axis relative to the distal end of the lift arm. The linkage referred to above is a parallelogram linkage defined by the lift arm 120 as one long leg of the parallelogram, a fixed length rod 142 as a parallel second long leg of the parallelogram, a plate 144 at the distal end of the lift arm as a short leg of the parallelogram which is also mounted on a bearing 146 that permits relative rotation of the manifold and the plate 144 and a mounting bracket 148 (FIGS. 3B, 3C and 3D) at the proximal end of the lift arm as the other short leg of the parallelogram to which both the lift arm and the fixed length rod are pivotally connected.

The operation of the parallelogram linkage is possibly best appreciated by reference to FIG. 3C. An operating power cylinder 150 has its housing pivotally connected to the plate 144 and its plunger 152 pivotally connected to a lever arm 154 which is in turn fixed to the manifold 122 so pivotal movement of the lever arm about the horizontal axis of the manifold causes the manifold to pivot correspondingly. Such movement, however, is independent of the plate 144 and the lift arm 120 as they are connected to the manifold with bearings.

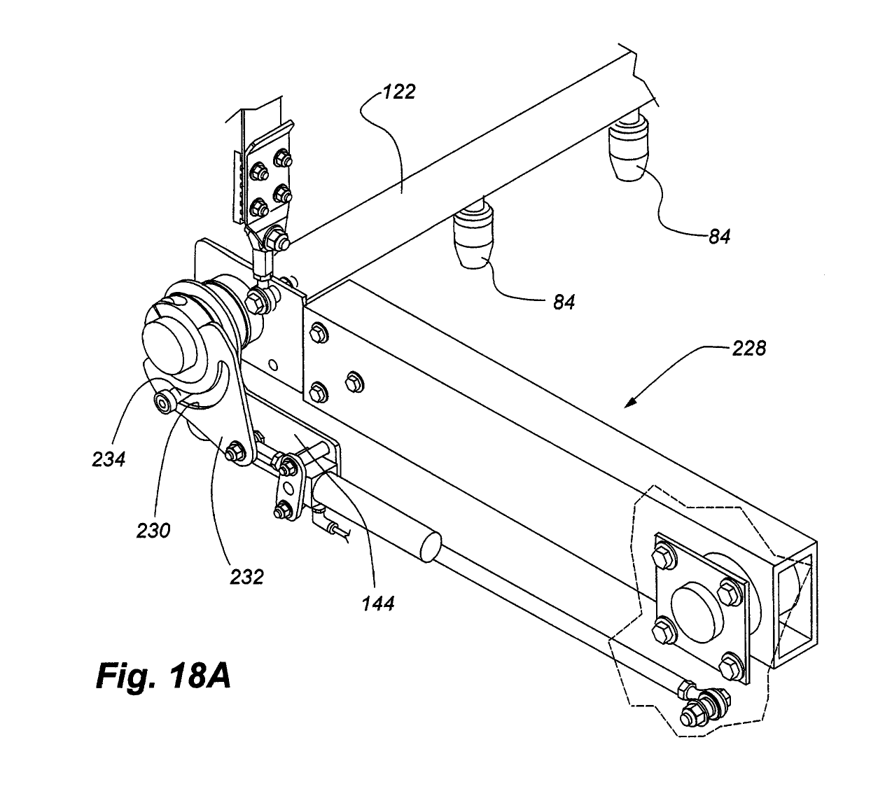

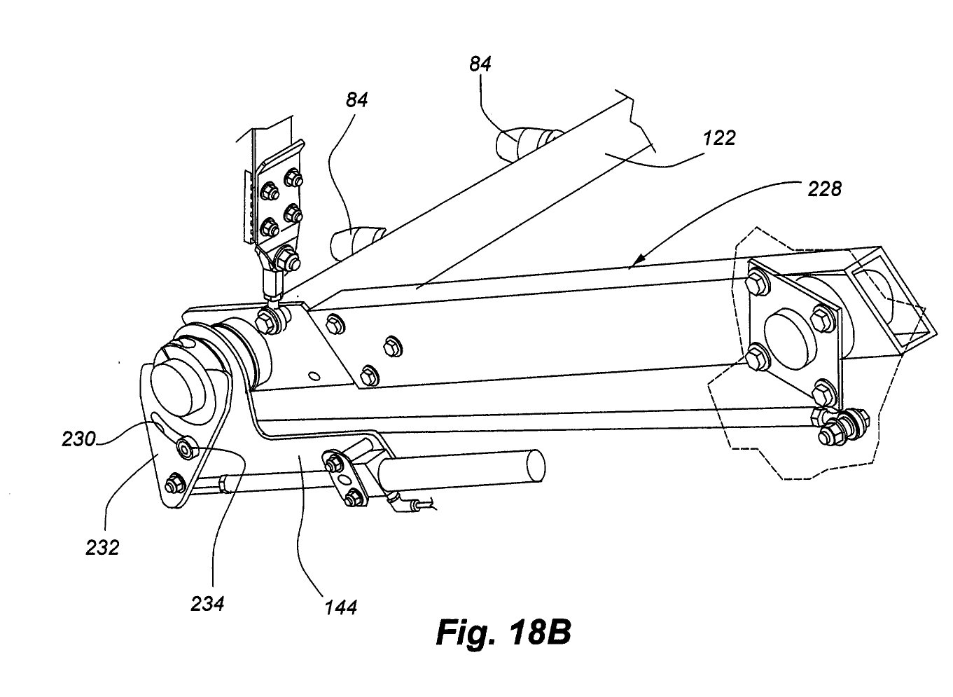

As an alternative to the arrangement shown in FIG. 3C, FIGS. 18A and 18B illustrate the lift arm 228 with a parallelogram linkage that has been slightly modified by providing an arcuate slot 230 in a lever arm 232 and a guide pin 234 projecting from the plate 144 through the arcuate slot with the length of the arcuate slot defining the pivotal movement permitted for the lever arm 232. By providing an arcuate slot with a guide pin as illustrated, the pivotal movement of the manifold 122 on which the nozzles 84 are mounted is precisely controlled such that the pivotal movement in one direction can be for example at one limit of the arcuate slot as illustrated in FIG. 18A and at another limit as illustrated in FIG. 18B.

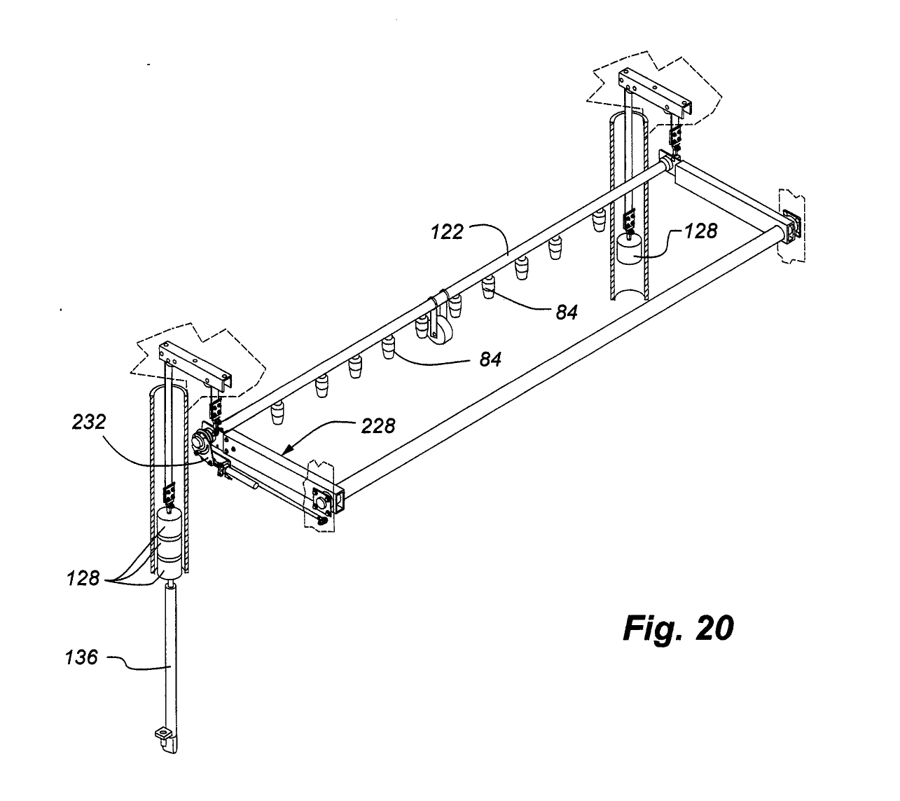

In the alternative embodiment to the overhead boom, the slidable weights 128 provided in the counterbalance system (FIG. 20) have been varied so there are three such weights on the side of the boom having the drive cylinder 136 while there is only one weight on the opposite side of the boom. Of course, the number of weights is not important but rather the regulation of the relative weight on one side or the other of the boom has been found to have a positive affect on the operation of the boom.

FIG. 3G is an isometric enlargement of the connection of the operating cylinder 150 to the plate 144 and the plate to the manifold 122 as well as the fixed length rod 142 and the lift arm 120. In FIGS. 3G, the boom 40 is shown in the elevated or retracted position of FIG. 3C wherein it will be appreciated the nozzles 124 are angled downwardly and upstream at about a 45 degree angle to vertical. When the boom is lowered as by activating the drive cylinder 136 which lifts the counterbalance weights 128 allowing the boom to drop by gravity, the lift arms drop to approximately a downwardly and downstream 45 degree angle, but due to the parallelogram linkage, the nozzles remain pointing downwardly and upstream at approximately a 45 degree angle. During this transition, it is appreciated the operating cylinder 150 is retracted. The orientation of the nozzles, however, can be changed to the position of FIG. 3E where they are directed downwardly and downstream at approximately a 45 degree angle by activating the operating cylinder 150 which extends its piston rod 152. Of course retraction of the piston rod would again pivot the nozzles back to the position of FIG. 3D. The activated position of the operating cylinder is shown in FIG. 3F in more detail. The orientation of the nozzles on the boom manifold are important to the operation of the apparatus as will be described hereafter.

An upper 158 and lower 160 adjustable bumper stops are also incorporated into the overhead housing component of the apparatus to limit pivotal movement of the lift arms 120 between the raised position of FIG. 3C and the lowered position of FIG. 3D. In the raised position, the upper bumper stop, shown connected to the top of the overhead housing component, has an adjustable head 162 to properly position the lift arm at its uppermost limit and in FIG. 3D, the lower bumper stop is shown having an adjustable bumper head 164 abutting the lift arm in its lowermost position.

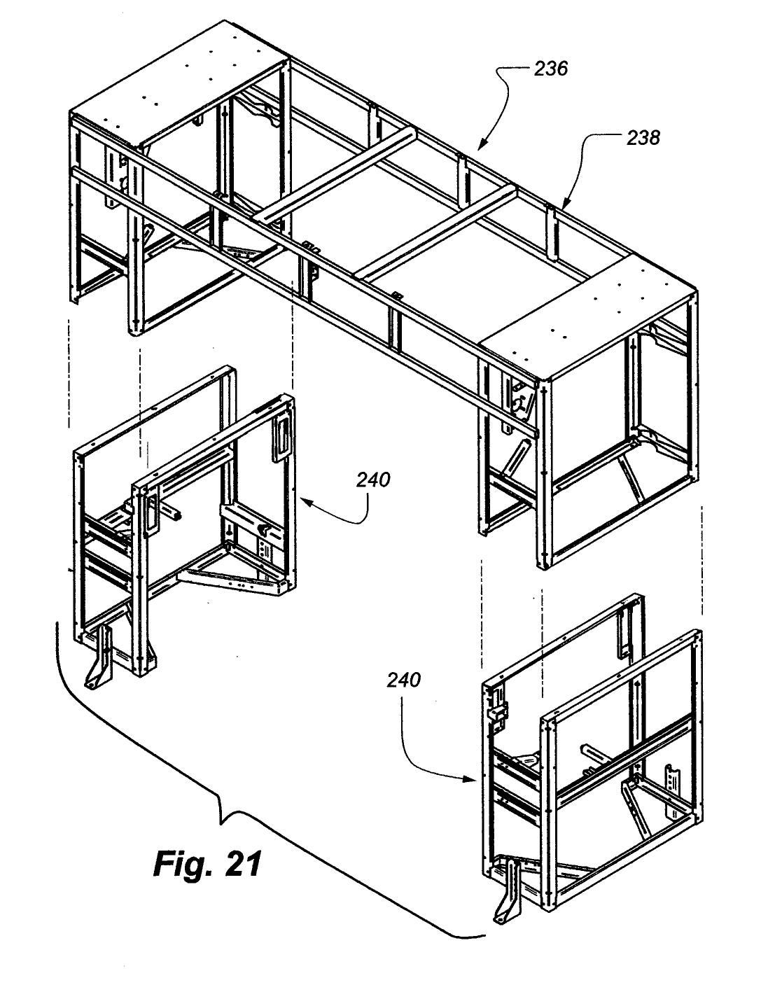

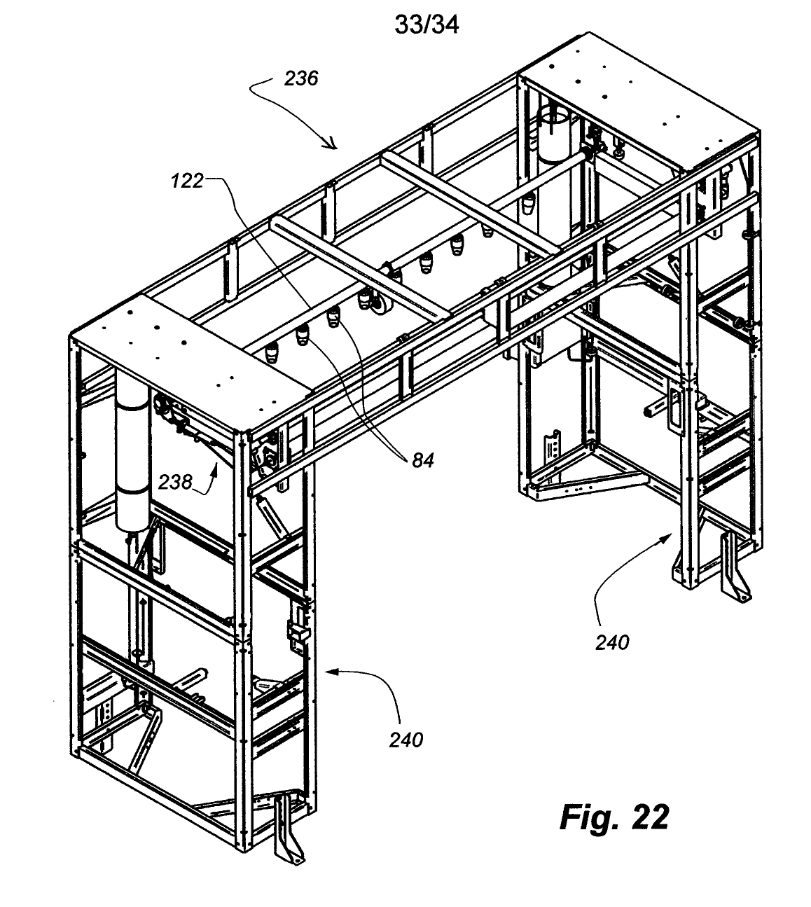

FIGS. 21 and 22 illustrate a framework 236 for the U-shaped housing 12 and with initial reference to FIG. 21, the framework can be seen to generally comprise three components. The first component 238 includes the overhead housing component 32 and upper portions of the two side housing components 30 while the two other modules 240 consist of lower portions of the side housing components 30. Of course, the modules can be interconnected at an assembly site but are sized for convenience in shipping. The framework illustrated in FIG. 21 would also be covered with an outer skin or layer (not shown) of a desirable material such as plastic, aluminum, or the like to at least partially conceal the working components of the system when they are mounted on the framework.

With reference to FIG. 22, the framework 236 is shown assembled and with the overhead boom portion of the wash apparatus incorporated therein. The pivotal side arms have been removed for a better view of the framework within the U-shaped housing 12.

As mentioned previously, the nozzles used in the apparatus are of the rotary turbo type emitting a rapidly circulating jet of cleaning liquid defining a cylindrical spray pattern and can be sized and configured to accommodate the spacing of the nozzles from the vehicle. In other words, the nozzles 124 along the boom might be of one size and speed of rotation while the lower two nozzles of the fixed set of nozzles 38 are of another size and speed, the upper fixed nozzles of still another size and speed and the nozzles 84 on the side arms 34 of a further size and speed. The sizes and speed of the nozzles are not necessarily different, but to optimize the cleansing capabilities of the nozzles relative to the surface of the vehicle, it has been found individually the nozzles should be selected for the different locations in the apparatus. Rotary turbo nozzles of the type found desirable for the apparatus of the invention are described in detail in U.S. application Ser. No. 10/791,340 filed Mar. 1, 2004, which is a continuation-in-part of U.S. Pat. No. 6,807,973. The disclosures in the application and patent are hereby incorporated by reference. Consistent with those disclosures, the nozzles across the boom would preferably have a range of 40 to 42 inches while the nozzles on the side arms would have a range of 42 to 44 inches, the lower two nozzles on the set of fixed nozzles would have a range of 24 to 36 inches, and the upper fixed nozzles would have a range of 28 to 30 inches. By range, it is meant the maximum distances at which optimal cleansing impingement force from the emitted spray is obtained.

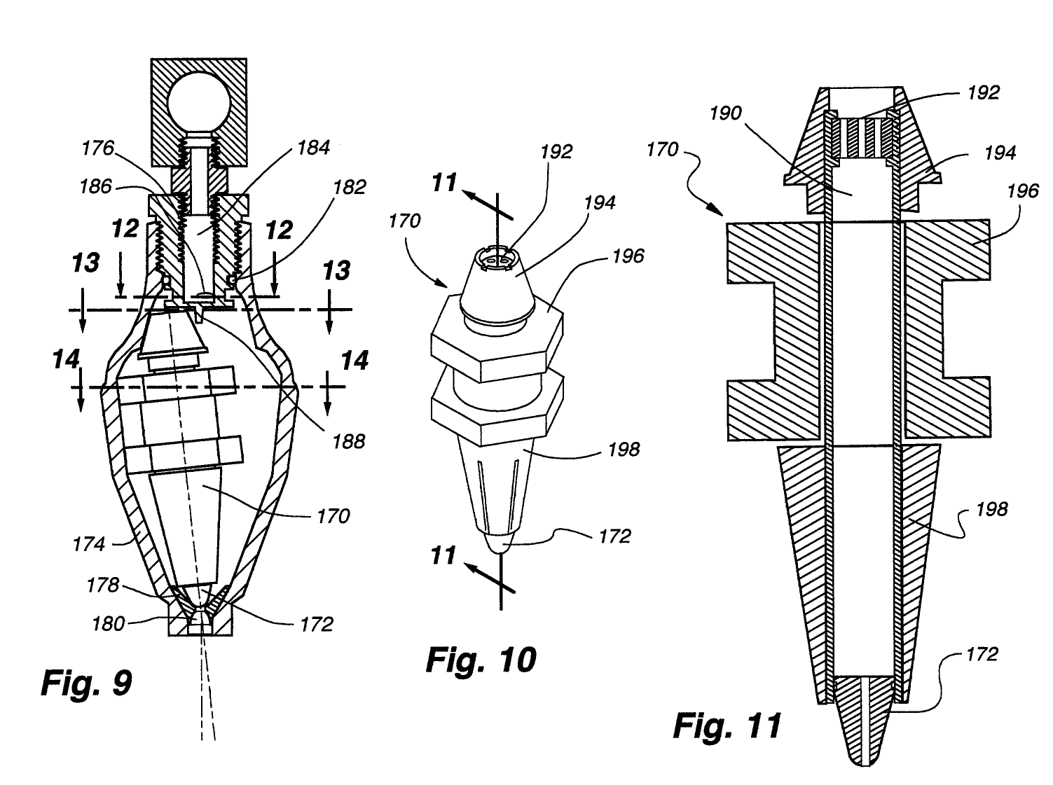

The nozzles can be best appreciated by reference to FIGS. 9-17 and will be described as fast and slow rotating turbo nozzles for convenience of description. As illustrated in FIG. 9, both fast and slow rotating turbo nozzles comprise a rotating nozzles member 170 having an orifice 172 that rotates within a body 174 of the nozzle causing a fluid jet emanating therefrom to assume a spiral shape as illustrated in FIG. 6 for example. This causes a single turbo nozzle to have a circular impact area, which makes obtaining complete coverage of the vehicle surfaces simpler. For instance, in certain circumstances, the use of fast rotating turbo nozzles results in better coverage of the vehicle surfaces and more effective cleaning of the surfaces than would a zero degree nozzle which is well known in the industry and provides simply a straight jet stream of liquid. Fast rotating turbo nozzles, in which the nozzle orifice rotates at speeds of around 2600 to 3000 rpm, are commercially available in a variety of sizes from several vendors and have been utilized in various applications on vehicle wash systems. However, fast rotating turbo nozzles suffer from a drawback that has limited their application in certain vehicle wash system applications, namely, they have a limited effective range of 28″ to 36″ depending on the size of the fast rotating nozzle specified. At distances in excess of the effective range, the circulating fluid jet loses its integrity and becomes a mist, which although increasing the coverage of the underlying surface, does not impart enough of an impact force on the vehicle to effectively dislodge dirt and debris. It can be appreciated the total distance traveled by any portion of cleaning solution in a circulating liquid jet as it circulates towards a vehicle's surface is much greater than the distance between the nozzle orifice and the surface to be cleaned. In other words, the length of an uncoiled circulating jet would be much greater than the distance between the nozzle tip and the surface of the vehicle. It follows therefore, that the aerodynamic drag incident on a circulating fluid jet from mist and air would be significantly greater than on a comparable straight fluid jet (such as from a zero degree nozzle). This aerodynamic drag tends to dissipate some of the circulating jets energy. Furthermore, the complex force vectors acting on the circulating liquid jet as it leaves the nozzle and travels towards the vehicle surfaces tends to compromise the integrity of the circulating jet contributing to its effective disintegration at much shorter distances than a comparable straight fluid jet.

Slow rotating turbo nozzles in accordance with the present invention and as their name would suggest rotate at greatly reduced rates in the range of 600-2600 rpm when compared to their fast rotating cousins. The fluid jets emanating from slow rotating nozzles circulating at a significantly slower rate than their fast rotating cousins making fewer turns before reaching the surface of the vehicle. The drag on a fluid jet from a slow rotating turbo nozzle would be less than that of a jet from a fast rotating turbo nozzle situated a similar distance from a vehicle surface. The fluid jet of a slow rotating turbo nozzle would, therefore, encounter less aerodynamic energy dissipation than its fast rotating cousin. Accordingly, in accordance with the present invention it has been discovered that a slow rotating turbo nozzle has a greater effective range than fast rotating nozzles (similarly sized fast and slow rotating turbo nozzles have approximate ranges of 28″-36″ and 36″-49″ respectively) for delivering the same impact force to the surface of a vehicle. Even at distances within the effective ranges of the fast rotating turbo nozzle, the slow rotating turbo nozzles deliver a fluid jet having a greater impact force per unit area than the comparable fast rotating turbo nozzle. By using slow rotating turbo nozzles in a vehicle wash system, all surfaces of the vehicle can be hit with jets of cleaning solution at effective levels of impact force to dislodge most dirt and debris, especially those on contoured surfaces of a vehicle that might be outside of the range of fast rotating turbo nozzles.

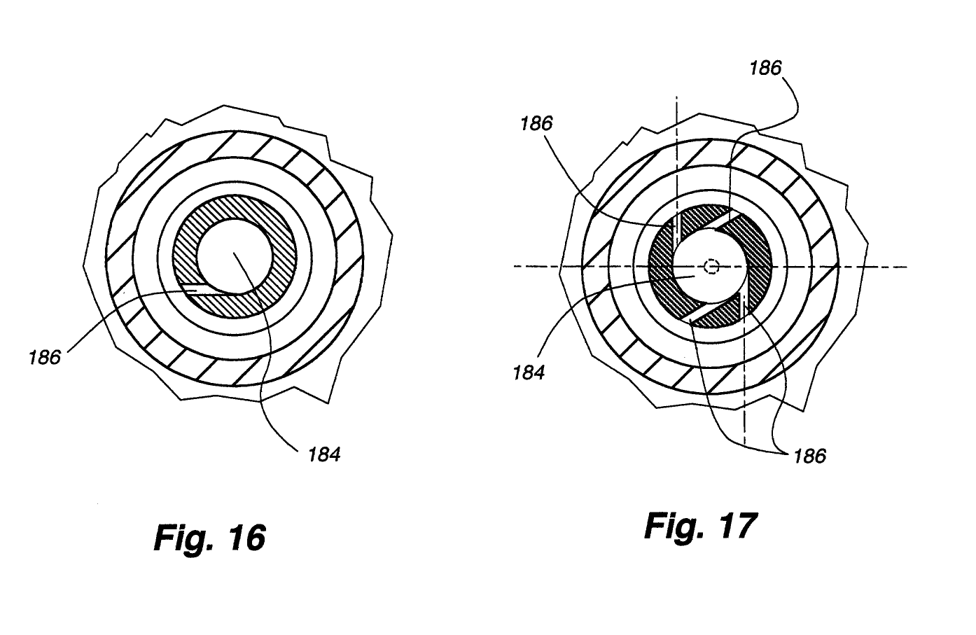

FIGS. 9-15 and FIG. 17 illustrate slow rotating turbo nozzles. Furthermore, FIG. 16 illustrates a cross section of a fast rotating turbo nozzle for purposes of comparison. Unless otherwise indicated, the description provided herein generally applies to both fast and slow rotating turbo nozzles. Distinctions between the fast and slow turbo nozzles will be specifically indicated.

As shown in FIG. 9, a typical turbo nozzle comprises three basic components: the nozzle body 124; an inlet cap 176 that is threadably received into the top of the body; and the rotating nozzle member 170 that is contained within the body. The hollow interior or peripheral wall of the nozzle body 174 has a generally conical shape so as to be of circular transverse cross-section beginning with a threaded opening to receive the inlet cap 176 at a distal end. From the distal end, the walls of the body 174 taper until terminating at the proximal end in a ceramic seat 178. The ceramic seat 178 has a concave inside surface configured to receive the orifice of the rotating nozzle member and a passage 180 therethrough to permit the fluid jet emanating from the orifice to exit the turbo nozzle typically at an angle of approximately 12 degrees from the longitudinal axis of the body 174.

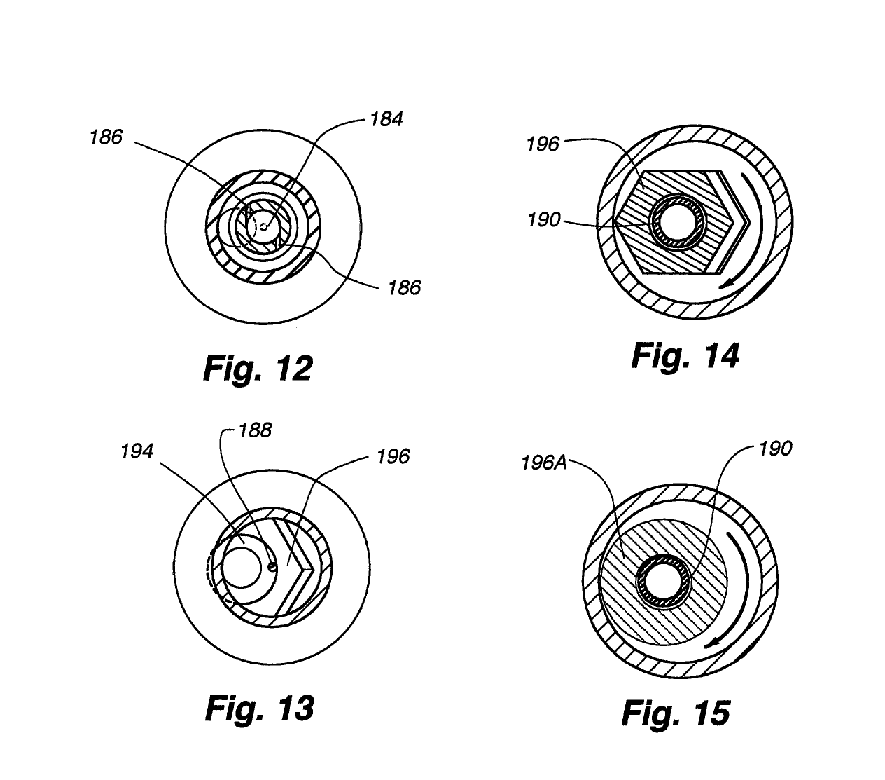

The inlet cap 176 is a generally cylindrical member having a partially threaded outside surface for being received into the threaded opening of the nozzle body 174 with an o-ring seal 182 disposed thereon. The inlet cap 176 further comprises a vertical bore 184 that is partially threaded for coupling with a cleaning solution supply manifold or hose. The bore is closed at its bottom end; however, two jet passageways 186 extend through the vertical wall of the bore 184 at generally acute angles relative to the surface surrounding the hollow interior of the nozzle body. The passageways communicate with the interior of the nozzle body 174 as illustrated in FIG. 12. The angle that the passageways 186 extend relative to the surface surrounding the hollow interior, the diameter of the passageways and the interaction between the fluid jets emanating therefrom during operation are all critical in determining the rotational speed of the turbo nozzle as will be described below. Lastly, a small nib 188 extends from the center of the outside surface of the closed bottom end of the inlet cap 176 for reasons that will become apparent.

The rotating nozzle member 176 is illustrated in isolation in FIGS. 10 and 11. The rotating nozzle member 170 typically comprises a brass tube 190 having a perforated support piece 192 spanning the interior of the tube proximate to its distal end to provide support and additional strength thereto. The proximal end of the tube is capped with the ceramic orifice 172 from which the spiraling jet of the turbo nozzle emanates. The ceramic orifice 172 has a generally conical shape that terminates in a rounded end. The rounded end is sized to nest in the concave portion of the ceramic seat 178 such that when under pressure the ceramic orifice 172 effectively seals the passage through the ceramic seat 178. The diameter of the ceramic orifice 172 ultimately controls the volumetric output of the nozzle.

The outside surface of the brass tube 190 is covered by one or more plastic shrouds 194, 196 and 198. In general, the plastic shrouds serve to protect the brass tube 190 as the nozzle member 170 is rotated within the nozzle body 174 at high speeds. Depending on the particular configuration of the turbo nozzle, a single unitary plastic shroud maybe utilized, although as illustrated, three separate and distinct shrouds are indicated. The upper shroud 194 serves to guide the nozzle member 170 around the nib 188, as best illustrated in FIGS. 9 and 13. The middle shroud 196, which is shown having a non-circular polygonal preferably hexagonal outer surface, serves to guide the nozzle member 170 along the inside surface of the nozzle body 174 as best illustrated in FIG. 14. Because the middle shroud 196 is hexagonal, it will cause the orifice 172 to rotate in a more hexagonal pattern, thereby slightly altering the characteristics of the fluid jet emanating therefrom. Furthermore, the hexagonal surface of the middle shroud 196 will not rotate as easily around the inside surface of the nozzle body 174, as would a round or circular surface which would be used on the fast rotating nozzle of FIG. 16, thereby increasing the rotational friction of the nozzle member 170, slowing its effective rate of rotation even further. As illustrated in FIG. 15, the hexagonal shroud 196 can be replaced with a circular shroud 196A of the type used in fast rotating nozzles to increase the speed of rotation, if desired.

The operation of a typical turbo jet will now be described. First, the cleaning solution enters the inlet cap 176 from a source under high pressure. The cleaning solution then travels through the one or more passageways 186, wherein the cleaning solution is accelerated and is propelled from the nozzles as a stream in a direction generally perpendicular with the center axis of the turbo nozzle towards the corresponding inner surface of the body 174. The stream impacts inner surface of the body 174 at an acute angle, which induces the cleaning solution to rotate in a clockwise direction. A clockwise vortex of cleaning fluid is created within the body 174 which is completely filled with the pressurized cleaning solution during operation. By reversing the angle of incidence between the stream and the wall of the body, a counterclockwise vortex could be created as well. The vortex causes the nozzle member 170, which is in its path, to rotate at essentially the same velocity as the vortex. It is appreciated that the nib 188 prevents the nozzle member 170 from positioning itself in the calm center of the vortex. Next, the pressurized cleaning fluid contained in the body is forced into the top end of nozzle tube 190 and through the orifice 172, wherein the cleaning solution is accelerated and exits the nozzle in the form of a spiraling fluid jet again typically at an angle of approximately 12 degrees off the longitudinal axis of the body 174.

The speed of rotation of the nozzle and the speed of rotation of the fluid jet emanating therefrom is directly related to the rotational velocity of the vortex created within the nozzle body 174. It has been found that the velocity of the vortex is dependent on both the angle at which the fluid streams emanating from the inlet cap passageways 186 are incident on the inner surface of the body wall, as well as, the velocity of the streams. A horizontal cross section of a typical fast rotating turbo nozzle showing a single passageway 186 through the bore 184 in the inlet cap 176 into the body of the nozzle is illustrated in FIG. 16. A corresponding section of a slow rotating turbo nozzle in accordance with the present invention is illustrated in FIG. 17, wherein four passageways 186 are shown. The four passageways 186 have a combined cross sectional area greater than that of the single passageway 186 of fast rotating turbo nozzle of FIG. 16. For a given pressure of fluid being passed through the passageways of both nozzles, therefore, the fluid stream emanating from the single passageway of the fast rotating nozzle will be faster than the streams emanating from each of the four passageways of the slow rotating turbo nozzle. Accordingly, the rotational speed of the vortex created in the slow rotator will be less than the speed of the vortex in the fast rotator, resulting in a slower rotating nozzle member.

Other means of creating a slow rotating turbo nozzle are also contemplated. For instance, a set of one or more passageways 186 could pass through the inlet cap 176 at one angle while a second set of one or more passageways could pass through the inlet cap at a second angle, such that the streams emanating from the second set interfere with the vortex caused by the streams from the first set such that the speed of the vortex is reduced. For instance, streams from the first set of passageways 186 may induce a clockwise rotating vortex in the nozzle body 174 having a speed approaching that of a vortex in a fast rotating turbo nozzle. The streams from the second set of passageways may exit the passageways at angles that would by themselves induce a counterclockwise rotation. The combination of these two sets of streams effectively results in a vortex of a reduced speed. It is to be appreciated that a wide variety of combinations of sets of passageways can be utilized to tailor the speed of the vortex and consequently the rotational speed of the turbo nozzle to a desired level. The cross-sectional size of the passageway(s) can also be increased to reduce the rotational velocity of the nozzle member. As mentioned previously and in accordance with the present invention, this enables a reduction in the rotational speed of the nozzle and consequently an increase in the effective cleaning range of the nozzle.

In summarizing the above, it has been discovered that nozzles that rotate at speeds slower than conventional nozzles which have been referred to herein as fast-rotating nozzles have a greater effective cleaning range than do the fast rotating nozzles enabling a car wash apparatus to have the nozzles positioned at a greater distance from the surface of a vehicle and still obtain the same or better cleaning efficiency. Various systems for slowing the rate of rotation of a conventional fast-rotating nozzle have been described. As inferred above, nozzle bodies come in different sizes for handling different volumes of cleaning fluids but for purposes of illustration and not limitation, the following chart illustrates the advantages obtained with the present invention over fast-rotating nozzles by reference to a nozzle that emits 4.5 gals./min. of fluid that was delivered to the nozzle at a pressure of 4000 psi:

| Middle | Number of | Nozzle 170 | Preferred | Effective |
|---|---|---|---|---|
| Shroud 196 | Passageways | Range of | Operating | Cleaning |
| Shape | 186 | Rotating Speed | Rotating Speed | Range |
| round | 2 | 2600-300 | 2800 | 32″-36″ |
| hexagonal | 2 | 1400-2200 | 1800 | 38″-42″ |
| hexagonal | 4 | 600-1400 | 1000 | 46″-49″ |

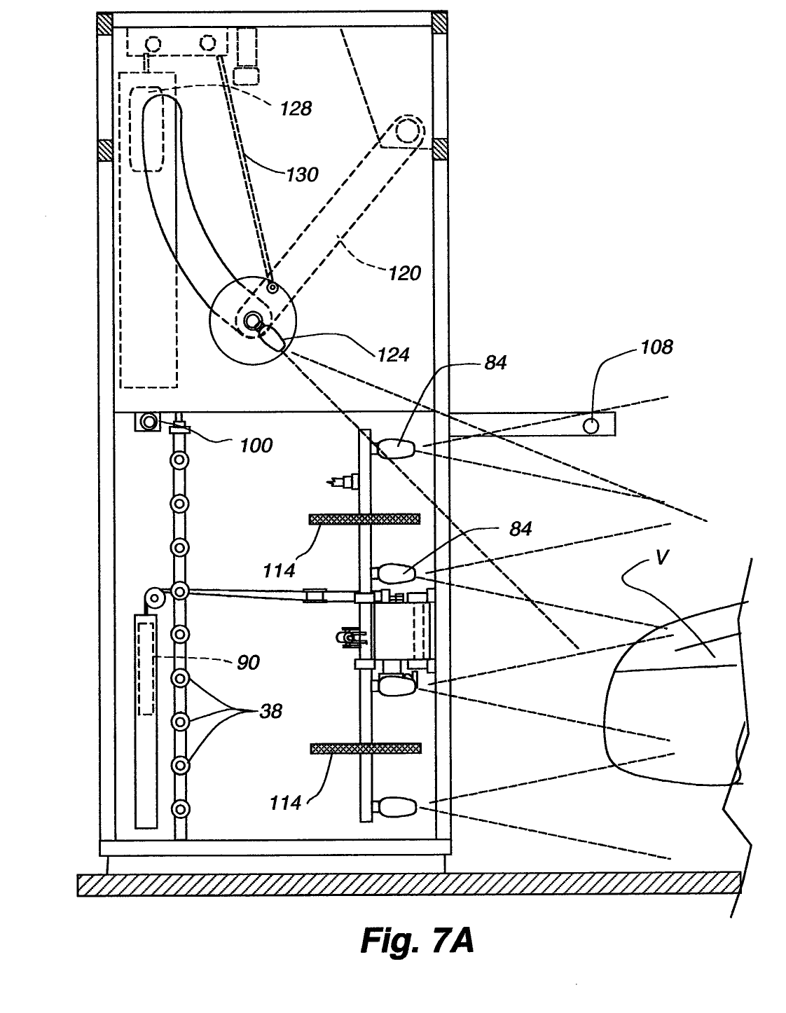

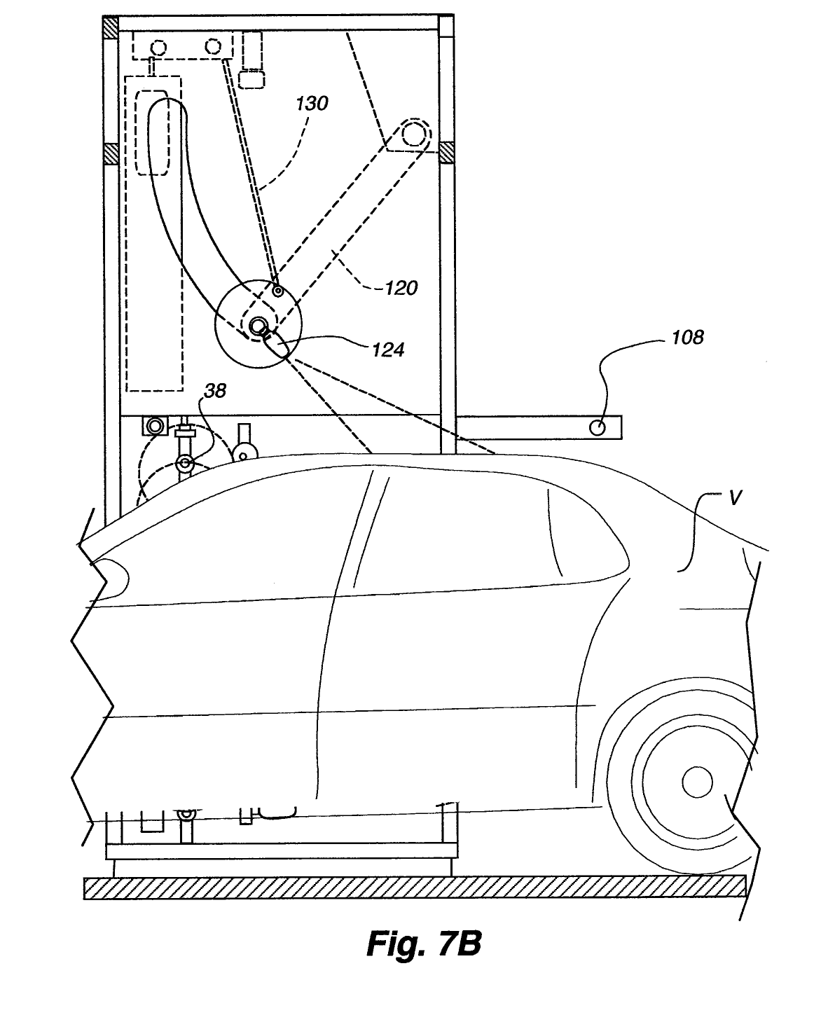

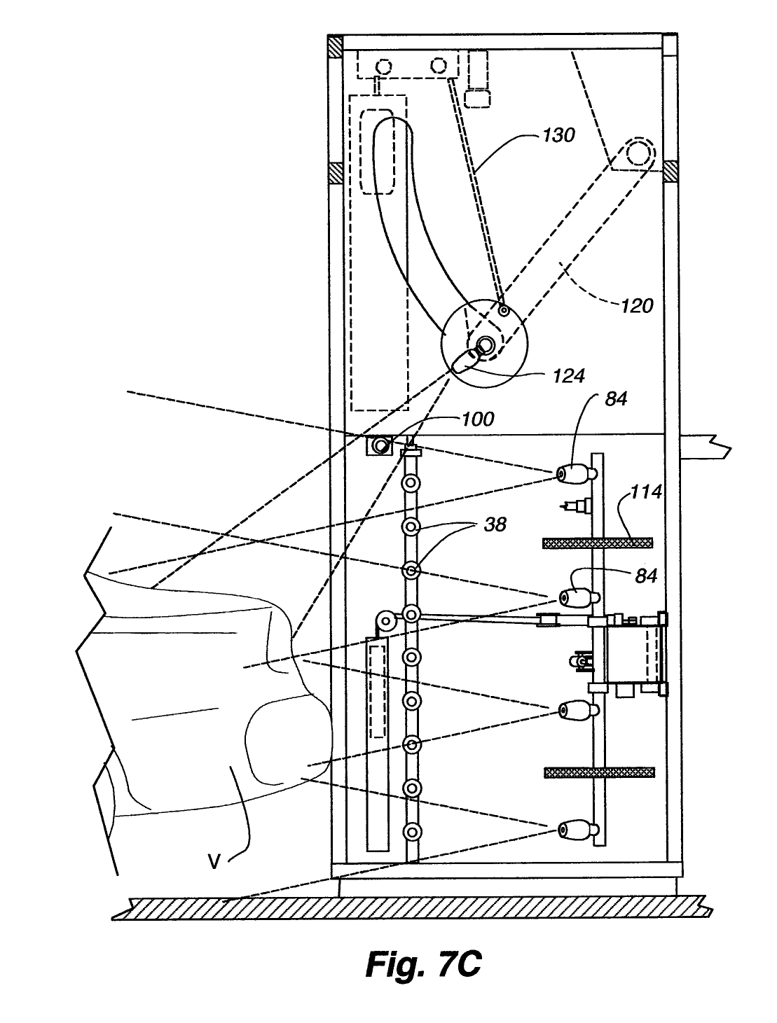

The operation of the apparatus of the invention is best illustrated by reference to FIGS. 6A through 8D. It is also important to note the operation would be slightly different if the apparatus were used as a reciprocating gantry (as mentioned previously) than as part of a tunnel system as described. When used in a tunnel system, a controller for the entire system follows the position of the vehicle so as it approaches the apparatus as seen in FIG. 6, the side arms 34 fully extend to the position seen in FIG. 7A and the overhead boom 40 is lowered to its lowermost position with the nozzles 124 on the overhead boom oriented as shown in FIG. 3D, i.e., with the operating cylinder 150 deactivated. As will also be appreciated, as the side arms as well as the overhead boom are being moved into position with the vehicle as positioned in FIG. 6A and 7A, the nozzles 84 and 124 will sweep the front of the vehicle with washing liquid in moving from their fully retracted to their fully extended positions. This gives complete coverage of the front end of the vehicle. If the apparatus were used as a reciprocating gantry so there was no tunnel system controller for monitoring the position of the vehicle, an additional upstream sensor beam from the infrared sensor beam 112 could be installed on the apparatus to advise the apparatus a vehicle was approaching and this sensor beam would replace the tunnel system controller.

With reference to FIG. 6B, when the vehicle has been advanced so that the front of the vehicle intercepts the infrared sensor beam 112, the side arms 34 are retracted by the computerized operating system which again sweeps water sprays across the front of the vehicle. Depending upon the height of the vehicle being washed which is determined by a height sensor 104 along the upstream wall of the housing, if the vehicle is of a relatively low profile as shown in FIG. 7B so as to be beneath the uppermost infrared sensor beam 106, the overhead boom 40 remains in the position of FIG. 7A even after the side arms have been retracted. Once the side arms are retracted, the nozzles 84 on the side arms are turned off and the fixed nozzles 38 are turned on as shown in FIG. 6C so the fixed nozzles commence spraying the sides of the vehicle adjacent to the front of the vehicle and remain on until the vehicle has passed the infrared sensor beam 102 as shown in FIG. 6D. Once the vehicle passes the infrared sensor beam, the side arms are again extended and the nozzles thereon are turned on with the nozzles being pivoted by the operating cylinders 74 so the nozzle heads point inwardly and downstream at approximately a 45 degree angle instead of directly upstream as when the vehicle first entered the apparatus. In this manner, as can be appreciated by referenced to FIG. 6D, the rear of the vehicle is swept by the sprays to rinse cleansing chemicals and the like from the rear of the vehicle. At the approximate time when the longitudinal center of the vehicle is in alignment with the nozzles on the overhead boom, the operating cylinder 150 on the boom is operated to pivot the nozzles 124 from the downwardly and upstream direction of FIG. 7B to a downwardly and downstream direction as shown in FIG. 7C so they will be properly directed to wash the rear of the vehicle as the vehicle leaves the apparatus.

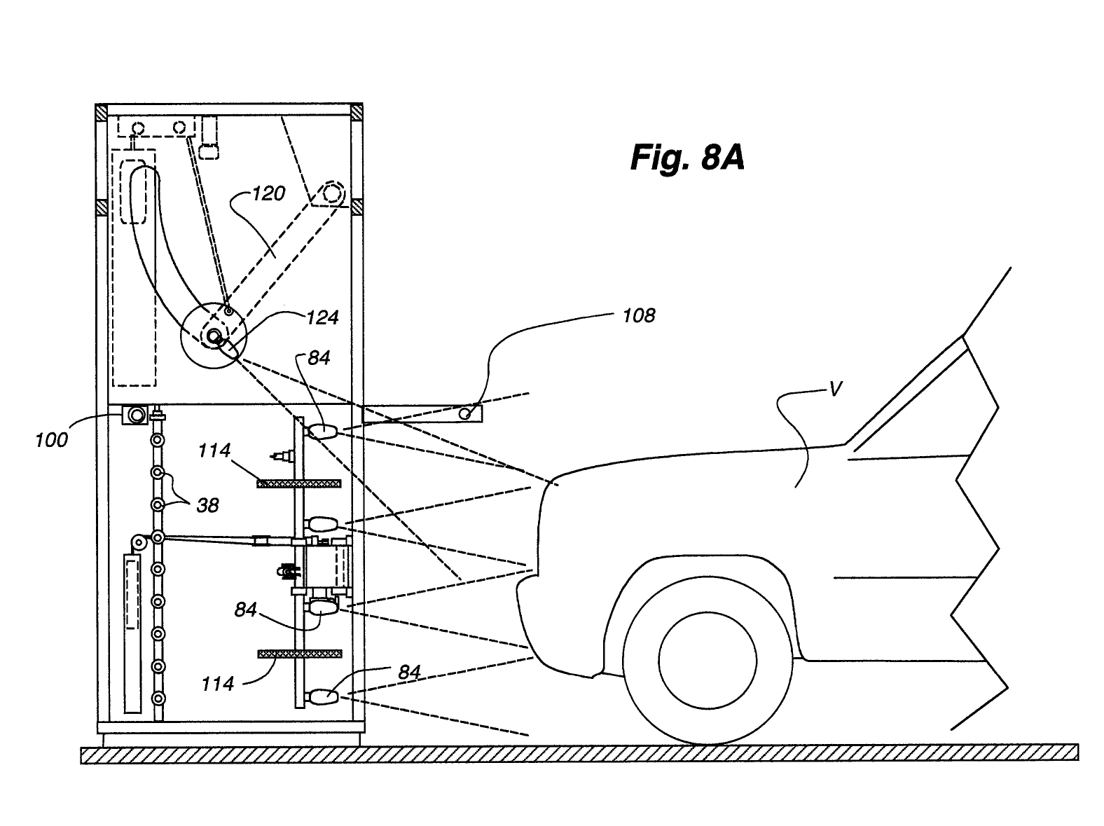

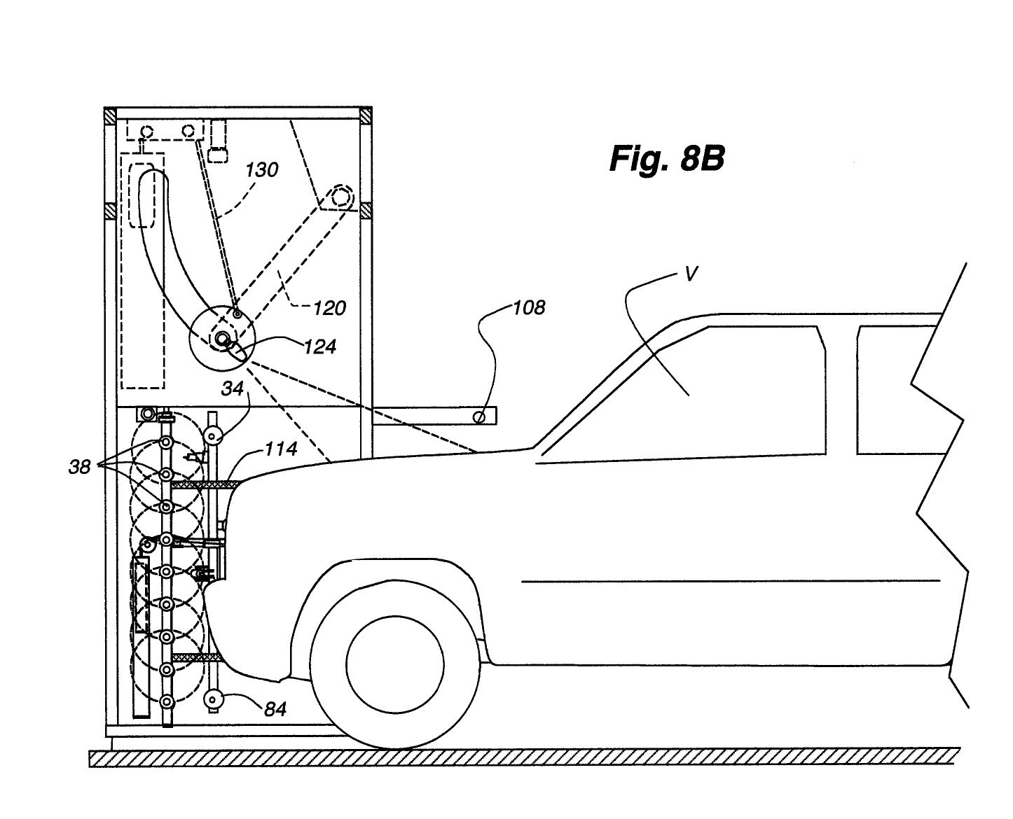

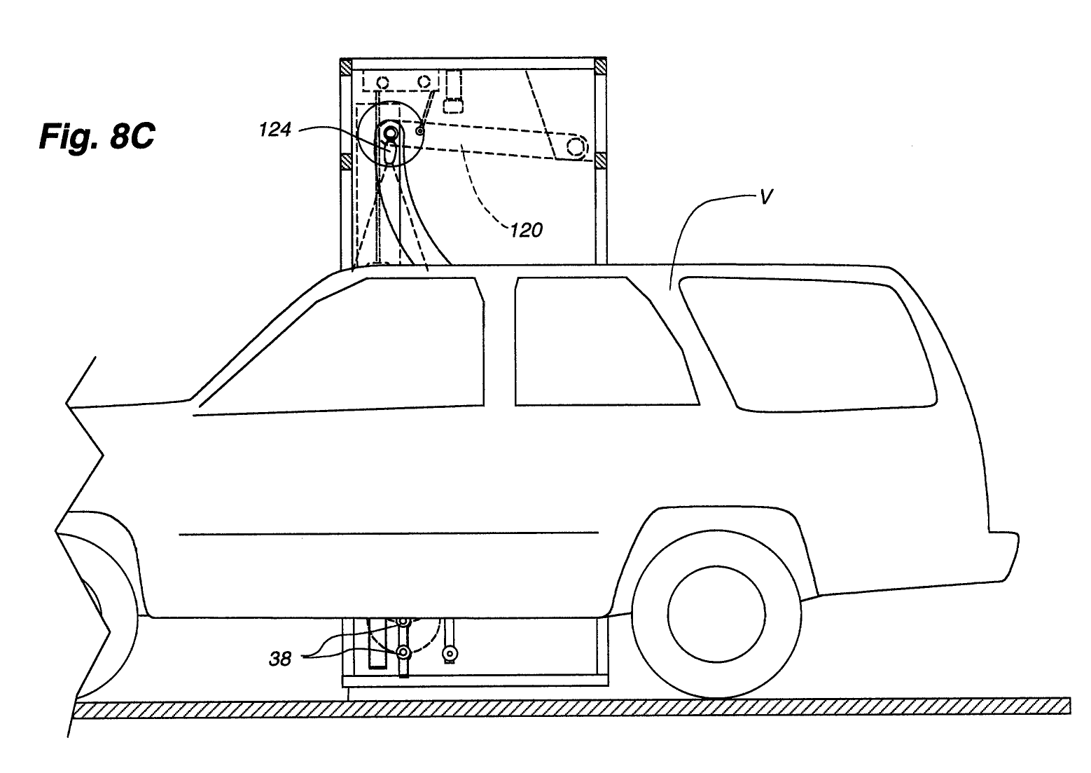

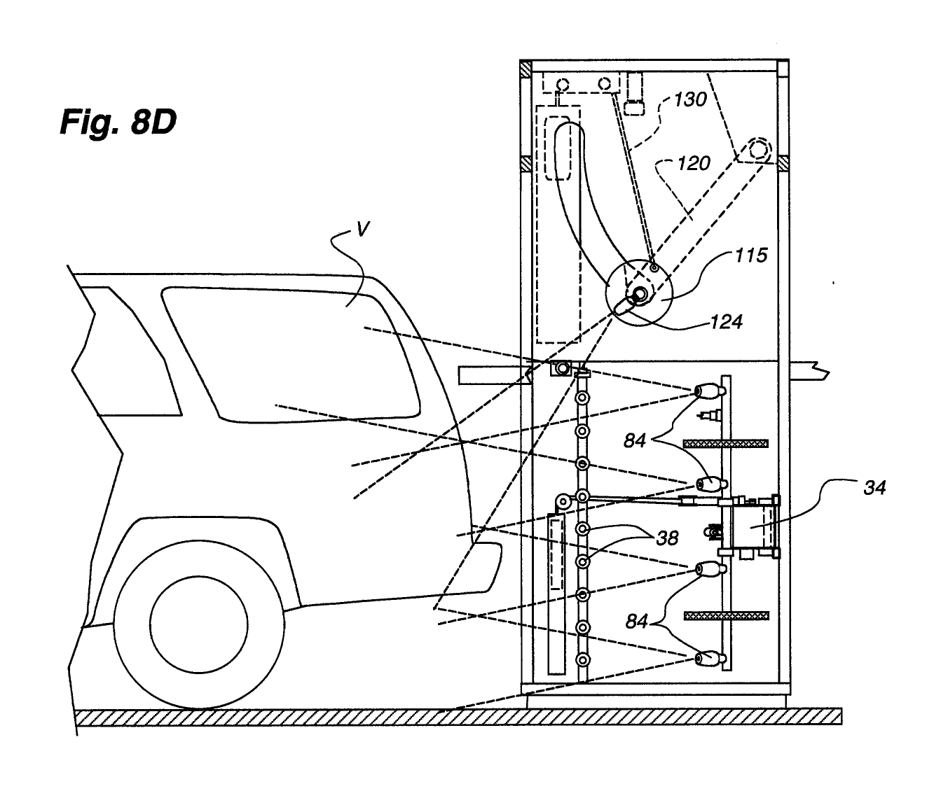

With reference to FIGS. 8A through 8D, the operation of the apparatus 10 on a relatively high vehicle such as an SUV is illustrated. In FIG. 8A, the vehicle V has intercepted the first infrared beam 112 thereby extending or lowering the overhead boom 40 and extending the side arms into the positions as illustrated in FIGS. 6A and 7A. After the vehicle has passed the second infrared beam 112, the side arms retract out of the way of the vehicle and once fully retracted, these nozzles are turned off and the fixed nozzles 38 are turned on so that when the vehicle approaches the fixed nozzles as seen in FIG. 8B, they are operative to spray washing liquid against the sides and wheels of the vehicle. It should be noted in FIG. 8B, however, that the overhead boom is still in a lowered position and it does not elevate until the vehicle intercepts the uppermost beam 106 on the upstream wall of the apparatus which tells the system that a relatively high vehicle is passing through the apparatus. That signal retracts the overhead boom by deactivating its drive cylinder so the counterbalancing weights raise the boom. The nozzles 124, however, remain in a downwardly and upstream direction until the center of the vehicle is approximately aligned therewith at which time the nozzles are pivoted with the operating cylinder 150 as shown in FIG. 8C so as to be directed in a downwardly and downstream direction as shown in FIG. 8D. Again, when the vehicle has passed the sensors 100 in the housing for the apparatus, the fixed nozzles are turned off and the side arms are swung outwardly while their nozzles are being pivoted about a vertical axis so as to be angled downstream rather than upstream as when the vehicle entered the apparatus.

As will be appreciated from the above, an apparatus has been described for washing a vehicle which could be incorporated into a tunnel type system wherein the apparatus would probably be used only for spraying high pressure rinsing fluid onto the vehicle to remove pre-soak chemical solutions and the debris and film they have chemically separated from the vehicle or could be used as a reciprocating gantry type apparatus that has not been described in detail, but wherein the nozzles in the apparatus would be used not only for spraying a rinsing high pressure fluid onto the vehicle, but also the pre-soak solution as well as rinses and waxes and the like through subsequent reciprocating passes of the apparatus across the vehicle as would be readily apparent to one skilled in the art.

The apparatus utilizes pivotal side arms with rotary turbo nozzles for desirably positioning the nozzles relative to the vehicle as it is moved past the apparatus and an overhead boom is similarly mounted with independent pivotal mounting of its nozzles for optimal cleansing of the vehicle.

Although the present invention has been described with a certain degree of particularity, it is understood the disclosure has been made by way of example and changes in detail or structure may be made without departing from the spirit of the invention as defined in the appended claims.

1. An apparatus for washing a relatively movable vehicle comprising in combination:
a pair of pivotal arms mounted in horizontally spaced relationship to provide therebetween a path of travel for said vehicle, said arms being pivotal about vertical axes between an extended position and a retracted position, and each arm including a plurality of spray nozzles with each spray nozzle being pivotal about a vertical axis different from said first-mentioned axes, the pivotal movement of said spray nozzles being positively limited.

2. The apparatus of claim 1 wherein the pivotal movement of said arms about said axes is positively limited in opposite directions of pivotal movement.

3. The apparatus of claim 2 further including a guide arm with an elongated slot therein and a guide pin in said slot for positively limiting said pivotal movement of said arms.

4. The apparatus of claim 1 wherein the extent of pivotal movement of said arms is adjustable.

5. The apparatus of claim 4 further including power cylinders for pivoting said arms said power cylinders being adjustably connected to said arms to control the extent of pivotal movement of said arms with said power cylinders.

6. An apparatus for washing a relatively movable vehicle comprising in combination:
an overhead boom transversely overlying a path of travel for said vehicle, said boom being pivotal about a horizontal axis between a raised position and a lowered position, said boom further including a plurality of horizontally spaced spray nozzles, said spray nozzles being pivotal about a horizontal axis different from said first-mentioned axis, the pivotal movement of said spray nozzles being positively limited.

7. The apparatus of claim 6 further including a guide plate with a slot therein and a guide pin in said slot for limiting said pivotal movement of said nozzles.

8. The apparatus of claim 7 wherein said slot is arcuate.

9. The apparatus of claim 6 wherein said boom further includes a drive cylinder for pivotally moving said boom.

10. The apparatus of claim 9 wherein said boom has opposite ends and said drive cylinder is disposed at only one end of said boom.

11. The apparatus of claim 10 further including a weighted counter-balance system operatively connected to said boom to bias said boom toward its raised position.

12. The apparatus of claim 11 wherein said counter-balance system includes weights at opposite ends of said boom.

13. The apparatus of claim 12 wherein the weights are heavier at the end of said boom having said drive cylinder than at the opposite end of said boom.

14. The apparatus of claim 13 wherein there is approximately three times as much weight at the end of said boom having the drive cylinder than at the opposite end of said boom.
